(19) United States
(12) Patent Application Publication
(10) Pub. No.: US 2026/0251474 A1
(43) Pub. Date: Aug. 27, 2026

(54) SYSTEMS AND METHODS FOR SCALABLE AUTOMATED STATIONING AND MONITORING OF CONSTRUCTION SITES

(71) Applicant: Haul Hub, Inc., Boston, MA (US)

(72) Inventors: Joseph SPINELLI, Harvard, MA (US); Corey PARADIS, Dover, NH (US); Prajyot BANKADE, Stow, MA (US); Michael LEE, Cresskill, NJ (US); Simon OLSBERG, Newton, MA (US)

(21) Appl. No.: 19/382,755

(22) Filed: Nov. 7, 2025

Related U.S. Application Data
(60) Provisional application No. 63/762,954, filed on Feb. 25, 2025.
(60) Provisional application No. 63/822,969, filed on Jun. 13, 2025.

(51) Int. Cl. G01C 21/00; G01C 21/36

(52) U.S. Cl. CPC G01C 21/3811; G01C 21/3661; G01C 21/3837; G01C 21/3896

(57) ABSTRACT

Systems and methods are described for automating creation and management of alignments, stations, and work zones related to civil construction projects. Alignments are generated and processed to include geographic coordinates for start and end points. A station equation and digital stations along the alignment are generated using the start and end points of the alignment. In some examples, work zones are generated based on the alignments. The work zones and relevant data signals are monitored for geographic proximity of the data signals according to rules which may trigger transmission of navigation alert changes to downstream data consumers. In some examples, delivered tickets or completed construction tasks are associated with the digital stations to maintain an as-built representation of the construction project.

### CROSS-REFERENCE TO RELATED APPLICATIONS

This application claims the benefit of priority to U.S. Provisional Application No. 63/762,954, filed on Feb. 25, 2025, and entitled “SYSTEMS AND METHODS FOR SCALABLE STATIONING OF CONSTRUCTION PROJECTS” and also claims the benefit of priority to U.S. Provisional Application No. 63/822,969, filed on Jun. 13, 2025, and entitled “SYSTEMS AND METHODS FOR SCALABLE STATIONING AND MONITORING OF CONSTRUCTION SITES,” the entirety of each of which are incorporated herein by reference.

### FIELD OF THE INVENTION

The invention relates to the field of construction project management and orchestration, and more specifically to the automated creation of geographical position markers for a construction site.

### BACKGROUND OF THE INVENTION

Large construction projects, such as highways, bridges, airports, and buildings, typically involve many parties, each with its own way of representing and storing data related to a project. For example, a state department of transportation (DOT) may use an electronic database to store project plans, identities of assigned employees, and a list of contractors working on each project. Each project may involve many contractors, such as pavers, steel erectors, and construction debris haulers. Each contractor on a given project may have its own paper or electronic database to keep track of hauls of construction materials to or from various construction sites. The contractors typically obtain construction materials, such as ready-mix concrete, aggregates, structural steel beams, hot-mix asphalt (HMA), timber, salt, etc., from suppliers, and sometimes contractors engage subcontractors to perform some tasks and/or to provide or haul some construction materials. Each of these suppliers and subcontractors may have its own paper or electronic database for keeping track of construction materials supplied or hauled to and from construction sites.

A project owner, such as a DOT, typically requires source documentation of construction materials delivered to construction sites. The source documentation must be created at a point of origin of the construction material, adequately describe the type and quantity of construction material delivered, and meet any other requirements relevant to the corresponding project. Source documentation requirements can be particularly stringent for projects funded by either or both state governments or federal government. Moreover, a contractor must typically fulfil these requirements before a project owner will pay the contractor for construction materials delivered to a construction site. The contractor is then responsible for paying corresponding suppliers and/or subcontractors. However, even when all involved parties maintain electronic databases, these databases are typically independently developed and often incompatible with and/or not communicatively linked to each other, consequentially necessitating manual case-by-case interventions to facilitate a meaningful exchange of information and payment for delivered construction materials.

More particularly, project owners plan and design projects according to various mapping data, typically based on state acquired survey data. Survey data may be out of date or simply incorrect, but project compliance and monitoring may nevertheless be associated with the state mandated data. This geographical plan data is often referred to as alignments, and notable locations along those alignments referred to as stations. Additionally, contractors, inspectors, and others working on the site will associate observations with the stations and alignments that correspond, in either or both of the project owner's IT infrastructure and according to various components of the project agreement, to the project owner's mapping data. However, often the people working on the site will either or both only have access to maps that do not directly incorporate the project owner's mapping data, or they may be constrained or even confused by a project owner's mapping data that is inaccurate or otherwise flawed.

It is with these, and other, considerations that the disclosed invention is described below.

### SUMMARY OF THE INVENTION

In some embodiments, a computer-implemented method for generating construction project station data includes accessing, by a server, construction project data including alignments of a construction project, automatically extracting, by the server, one or more of the alignments from the construction project data, determining, by the server, respective station values along each of the extracted alignments, generating, by the server, a station equation for one or more of the extracted alignments and the corresponding respective station values, wherein the station equation includes a back-station value and a back offset and a forward-station value and a forward offset, the back offset and the forward offset including respective values defining positional adjustments relative to the corresponding respective station values, geolocationally associating, by the server, one or more of the one or more extracted alignments, the corresponding respective station values, or the station equation to a mapping data standard, and storing, by the server and in a database associated with the construction project, project station data including the extracted alignments, the respective station values, the station equation, and the geolocational association, retrieving, by the server, the generated station equation from the database based on the construction project, and applying, by the server, the generated station equation responsive to the station values along one or more of the geolocationally associated alignments to provide consistent and accurate geographic positioning along the one or more of the geolocationally associated alignments, the one or more of the geolocationally associated alignments including one or more of a plurality of linearly adjacent alignments or a discontinuity, the discontinuity including one or more of an interruption or inconsistency in corresponding station values of one of the geolocationally associated alignments.

In some embodiments of the above computer-implemented method, applying the station equation includes calculating an offset between the back-station value and the forward-station value that corresponds to a single geographic location, and using the offset to reconcile downstream station values for continuity of numeric stationing across the one or more of the geolocationally associated alignments.

In some embodiments of the above computer-implemented method, the method further includes generating a set of station offsets, based on the station equation, for one or more of the extracted alignments, the station offsets respectively coupled to the corresponding respective station values.

In some embodiments of the above computer-implemented method, the method further includes rendering on an interactable display of a receiving device one or more of the extracted alignments and stationing information, based on the geolocational association and the station equation.

In some embodiments of the above computer-implemented method, the rendered alignments and stationing information are toggleable between visibility states and the interactable display includes a map based on the mapping data standard, the map including a location indicator that is reactive to a geographic location of the receiving device.

In some embodiments of the above computer-implemented method, geolocationally associating the extracted alignments, the corresponding respective station values, or the station equation to the mapping data standard further includes applying a projection accounting for curvature of the Earth.

In some embodiments of the above computer-implemented method, the applied projection is selected by a user.

In some embodiments of the above computer-implemented method, the construction project data is generated by a user interacting with an interactable map based on the mapping data standard.

In some embodiments of the above computer-implemented method, the method further includes receiving, by the server and from a user, a new alignment, and updating, by the server, the construction project data to include the new alignment.

In some embodiments of the above computer-implemented method, the method further includes providing the user a render of a government provided reference system as a guide for drawing the new alignment.

In some embodiments of the above computer-implemented method, the toggleable visibility states include (a) all alignments visible, (b) no alignments visible, (b) only automatically extracted alignments visible, and (c) only new alignments received from a user visible.

In some embodiments of the above computer-implemented method, the receiving device includes a mobile device.

In some embodiments of the above computer-implemented method, the method further includes associating, by the server, a physical location value of the receiving device with one or more of the station values based on one or more of a received selection interactable display or contextual factors including one or more of a proximity value of the geolocationally associated extracted alignments or the corresponding respective station values to the receiving device, a priority value, a task directly or indirectly associated with the receiving device, environmental data, time data, historical data, or financial data.

In some embodiments of the above computer-implemented method, the linearly adjacent alignments comprise one or more of merge or tie-in reoperations.

In some embodiments of the above computer-implemented method, the discontinuity comprises one or more of reset or re-baselining operations.

In some embodiments, a system for generating construction project station data includes a server including one or more computer processors, and a memory storing instructions to access, by a server, construction project data including alignments of a construction project, automatically extract, by the server, one or more of the alignments from the construction project data, determine, by the server, respective station values along each of the extracted alignments, generate, by the server, a station equation for one or more of the extracted alignments and the corresponding respective station values, wherein the station equation includes a back-station value and a back offset and a forward-station value and a forward offset, the back offset and the forward offset including respective values defining positional adjustments relative to the corresponding respective station values, geolocationally associate, by the server, one or more of the one or more extracted alignments, the corresponding respective station values, or the station equation to a mapping data standard, store, by the server and in a database associated with the construction project, project station data including the extracted alignments, the respective station values, the station equation, and the geolocational association, retrieve, by the server, the generated station equation from the database based on the construction project, and apply, by the server, the generated station equation responsive to the station values along one or more of the geolocationally associated alignments to provide consistent and accurate geographic positioning along the one or more of the geolocationally associated alignments, the one or more of the geolocationally associated alignments including one or more of a plurality of linearly adjacent alignments or a discontinuity, the discontinuity including one or more of an interruption or inconsistency in corresponding station values of one of the geolocationally associated alignments.

In some embodiments of the above system, the memory stores further instructions to render on an interactable display of a receiving device one or more of the extracted alignments and stationing information, based on the geolocational association and the station equation.

In some embodiments of the above system, the rendered alignments and stationing information are toggleable between visibility states and the interactable display includes a map based on the mapping data standard, the map includes a location indicator that is reactive to a geographic location of the receiving device.

In some embodiments of the above system, geolocationally associating the extracted alignments, the corresponding respective station values, or the station equation to the mapping data standard further includes applying a projection accounting for curvature of the Earth.

In some embodiments of the above system, the applied projection is selected by a user.

In some embodiments of the above system, the construction project data is generated by a user interacting with an interactable map based on the mapping data standard.

In some embodiments of the above system, the memory includes further instructions to receive from a user a new alignment, and update the construction project data to include the new alignment.

In some embodiments of the above system, the memory includes further instructions to provide the user a render of a government provided reference system as a guide for drawing the new alignment.

In some embodiments of the above system, the toggleable visibility states include (a) all alignments visible, (b) no alignments visible, (b) only automatically extracted alignments visible, and (c) only new alignments received from a user visible.

In some embodiments of the above system, the receiving device includes a mobile device.

In some embodiments of the above system, the memory includes further instructions to associate a physical location value of the receiving device with one or more of the station values based on one or more of a received selection, interactable display, or contextual factors including one or more of a proximity value of the geolocationally associated extracted alignments or the corresponding respective station values to the receiving device, a priority value, a task directly or indirectly associated with the receiving device, environmental data, time data, historical data, or financial data.

In some embodiments of the above system, the memory further includes instructions to associate, by the server, the physical location of the receiving device with one or more of the geographically associated alignments.

In some embodiments of the above system, the physical location is associated with the one or more of the geographically associated alignments based on whether the respective geographically associated alignment is in one of the toggleable visibility states.

In some embodiments of the above system, the physical location is associated with the one or more of the geographically associated alignments based on one or more of a plurality of contextual factors associated with the respective geographically associated alignment, the contextual factors including a proximity value of the respective geographically associated alignment to the receiving device, a priority value, a task directly or indirectly associated with receiving device, environmental data, time data, historical data, or financial data.

In some embodiments of the above system, the linearly adjacent alignments include one or more of merge or tie-in reoperations.

In some embodiments of the above system, the discontinuity includes one or more of reset or re-baselining operations.

In some embodiments, a non-transitory computer readable medium stores instructions that, when executed by one or more processors, cause the one or more processors to access construction project data including alignments of a construction project, automatically extract one or more of the alignments from the construction project data, determine respective station values along each of the extracted alignments, generate a station equation for one or more of the extracted alignments and the corresponding respective station values, wherein the station equation includes a back-station value and a back offset and a forward-station value and a forward offset, the back offset and the forward offset including respective values defining positional adjustments relative to the corresponding respective station values, geolocationally associate one or more of the one or more extracted alignments, the corresponding respective station values, or the station equation to a mapping data standard, store in a database associated with the construction project, project station data including the extracted alignments, the respective station values, the station equation, and the geolocational association, retrieve the generated station equation from the database based on the construction project, and apply the generated station equation responsive to the station values along one or more of the geolocationally associated alignments to provide consistent and accurate geographic positioning along the one or more of the geolocationally associated alignments, the one or more of the geolocationally associated alignments including one or more of a plurality of linearly adjacent alignments or a discontinuity, the discontinuity including one or more of an interruption or inconsistency in corresponding station values of one of the geolocationally associated alignments.

In some embodiments of the above computer readable medium, the instructions further cause the one or more processors to generate a set of station offsets, based on the station equation, for one or more of the extracted alignments, the station offsets respectively coupled to the corresponding respective station values.

In some embodiments of the above computer readable medium, the instructions further cause the one or more processors to render on an interactable display of a receiving device one or more of the extracted alignments and stationing information, based on the geolocational association and the station equation.

In some embodiments of the above computer readable medium, the rendered alignments and stationing information are toggleable between visibility states and the interactable display includes a map based on the mapping data standard, the map including a location indicator that is reactive to a geographic location of the receiving device.

In some embodiments of the above computer readable medium, geolocationally associating the extracted alignments, the corresponding respective station values, or the station equation to the mapping data standard further includes applying a projection accounting for curvature of the Earth.

In some embodiments of the above computer readable medium, the applied projection is selected by a user.

In some embodiments of the above computer readable medium, the construction project data is generated by a user interacting with an interactable map based on the mapping data standard.

In some embodiments of the above computer readable medium, the instructions further cause the one or more processors to receive, by the server and from a user, a new alignment, and update, by the server, the construction project data to include the new alignment.

In some embodiments of the above computer readable medium, the instructions further cause the one or more processors to provide the user a render of a government provided reference system as a guide for drawing the new alignment.

In some embodiments of the above computer readable medium, the toggleable visibility states include (a) all alignments visible, (b) no alignments visible, (b) only automatically extracted alignments visible, and (c) only new alignments received from a user visible.

In some embodiments of the above computer readable medium, the receiving device includes a mobile device.

In some embodiments of the above computer readable medium, the instructions further cause the one or more processors to associate, by the server, a physical location value of the receiving device with one or more of the station values based on one or more of a received selection interactable display or contextual factors including one or more of a proximity value of the geolocationally associated extracted alignments or the corresponding respective station values to the receiving device, a priority value, a task directly or indirectly associated with the receiving device, environmental data, time data, historical data, or financial data.

In some embodiments of the above computer readable medium, the linearly adjacent alignments include one or more of merge or tie-in reoperations.

In some embodiments of the above computer readable medium, the discontinuity includes one or more of reset or re-baselining operations.

In some embodiments of a computer-implemented method for alerting drivers of active work zones, the method includes receiving one or more safety work zones, each safety work zone including a collection of digital stations and one or more digital alignments associated with one or more construction project work sites, receiving a collection of rules for modifying an active status of each of the received one or more safety work zones based on data received from respective geographical sites corresponding to each of the received one or more safety work zones, receiving data from one or more devices deployed to one of the respective geographical sites, the data including information on device state, geolocation, and identification of an owner or a user, determining which of the received rules to apply to the received data based on one or more of the device, the geolocation, or the identification, modifying the active status of one or more of the received safety work zones by applying the received rules to the received data, wherein the modification to the active status is logged in project data store corresponding to the one or more of the received safety work zones, and transmitting a notification to a data consumer including a navigation service, wherein the notification is formatted in accordance with the data consumer.

In some embodiments of the computer-implemented method above, the one or more devices deployed to one of the respective geographical sites includes one or more of a paver, a miller, a front loader, a transportation vehicle, a drone, or a mobile device.

In some embodiments of the computer-implemented method above, the navigation service includes a third party application programming interface (API) endpoint accessible over the internet.

In some embodiments of the computer-implemented method above, receiving the data from one or more devices deployed to one of the respective geographical sites further includes fetching a collection of equipment statuses from a manufacturer endpoint using an authorization token associated with a corresponding equipment owner, and selecting equipment statuses from the collection by comparing location data of each respective equipment status with location data associated with the safety work zones, wherein the received data is thereafter limited to data associated with the selected equipment.

In some embodiments of the computer-implemented method above, the rules for modifying the active status comprises one or more of a rules-based model or a trained machine learning model.

In some embodiments of a computer-implemented method for generating as-built construction records, the method includes receiving digital stationing data including one or more digital station identifiers, corresponding geolocational data, and associated alignment data, receiving equipment data from construction equipment, the equipment data including an equipment identifier, geolocation data, and operating state data, determining a relevant digital station based on the received equipment data and the received stationing data, and updating or creating an as-built record including a reference to the determined relevant digital station and a construction activity based on the received equipment data.

In some embodiments of the computer-implemented method above, the equipment data further includes sensor data from one or more of a GPS, LiDAR, inclinometer, or temperature.

In some embodiments of the computer-implemented method above, receiving the equipment data further includes directly polling the construction equipment for the equipment data or querying a manufacturer endpoint for the equipment data.

In some embodiments of the computer-implemented method above, the construction activity is determined by one or more of applying a rules-based classifier to at least a portion of the received equipment data or applying a trained machine learning model to at least a portion of the received equipment data.

### BRIEF DESCRIPTION OF THE DRAWINGS

In order to describe the manner in which the advantages and features of the disclosure can be obtained, a more particular description of the principles briefly described above will be rendered by reference to specific embodiments or examples thereof which are illustrated in the appended drawings. Understanding that these drawings depict only exemplary embodiments of the disclosure, and are not therefore to be considered unduly limiting of its scope, the principles herein are described and explained with additional specificity and detail through the use of the accompanying drawings in which:

FIG. 1 is a block diagram of a computer according to some examples of the disclosed invention;

FIG. 2 is a system diagram of an infrastructure according to some examples of the disclosed invention;

FIGS. 3A-F depict an interface flow for generating new project stationing manually and automatically according to some examples of the disclosed invention, and prepared in anticipation of subsequent design filings;

FIGS. 4A-B depict an interface flow for toggling rendering of routes on a per-route basis for mobile devices according to some examples of the disclosed invention, and prepared in anticipation of subsequent design filings;

FIG. 5 depicts an interface for toggling rendering of routes on a per-route basis for mobile devices according to some examples of the disclosed invention, and prepared in anticipation of subsequent design filings;

FIG. 6 depicts an interface for manually generating routes and stations according to some examples of the disclosed invention, and prepared in anticipation of subsequent design filings;

FIGS. 7A-D depict a mobile view of a project including alignments and stationing data according to some examples of the disclosed invention, and prepared in anticipation of subsequent design filings;

FIGS. 8A-D depict an interface flow for creating safety work zones using alignments and stations according to some examples of the disclosed invention, and prepared in anticipation of subsequent design filings;

FIG. 9 depicts an example drawing of an active work site according to some examples of the disclosed invention;

FIG. 10 depicts an example drawing of a driver alert as a vehicle enters a safety work zone according to some examples of the disclosed invention;

FIG. 11 is a block diagram of a system for generating alignments and stationing according to some examples of the disclosed invention;

FIG. 12 is a flow chart of a method for generating alignments and stationing according to some examples of the disclosed invention;

FIG. 13 is a sequence diagram of a process sequence for generating alignments and stationing according to some examples of the disclosed invention;

FIG. 14 is a block diagram of a system for managing viewable station and alignment layers according to some examples of the disclosed invention;

FIG. 15 is a block diagram of a system for conciliation of field data with project data according to some examples of the disclosed invention;

FIG. 16 is a flow chart of a method for conciliation of field data with project data according to some examples of the disclosed invention;

FIG. 17 is a sequence diagram of a process sequence for conciliation of field data with project data according to some examples of the disclosed invention;

FIG. 18 is a block diagram of a system for managing safety work zones according to some examples of the disclosed invention;

FIG. 19 is a flow chart of a method for managing safety work zones according to some examples of the disclosed invention;

FIG. 20 is a sequence diagram of a process sequence for managing safety work zones according to some examples of the disclosed invention;

FIG. 21 is a flowchart of a method for managing station equations according to some examples of the disclosed invention;

FIG. 22 is a sequence diagram of a process sequence for generating stations data including a station equation according to some examples of the disclosed invention;

FIGS. 23-25 are views of an interface flow for exporting stations and alignments to a ledge style printout according to some examples of the disclosed invention, and prepared in anticipation of subsequent design filings; and

FIGS. 26-31 are views of an interface flow for importing stations and alignments from handwritten markup of plan printouts according to some examples of the disclosed invention, and prepared in anticipation of subsequent design filings.

### DETAILED DESCRIPTION OF EMBODIMENTS

Aspects of the disclosure may be supported by various information technology (IT) infrastructures, including either or both local architectures, either as monoliths, networked, or a combination thereof, and hosted architectures, such as a software as a service (SaaS), platform as a service (PaaS), and/or infrastructure as a service (IaaS), or the like. In an example, a supporting infrastructure includes multiple interconnected layers respectively hosting, as an abstraction, various IT processes, services, accounts, and other management components.

The layers of the supporting infrastructure may be divided into, for example and without imputing limitation, an operations layer, a client layer, an infrastructure layer, and an external integrated services layer. Each layer is generally structured around a designated aspect of the IT infrastructure supporting software product offerings, such as the embodiments described in the current disclosure, and is made of various components that each may include any or all of libraries, functions, application programming interfaces (APIs), data stores, and more.

In general, the client layer includes various interfaces through which end users are able to interact with offerings hosted and/or orchestrated by and across the infrastructure layer, either directly or indirectly. As examples, and without imputing undue limitation, mobile applications, web application, installed client binaries, service daemons, system processes, and the like, as well as client-side hardware components may operate principally within the client layer. The infrastructure layer includes various hosted and back-end services, including, for example and without imputing undue limitation, SaaS access points, collection, collation, aggregation, and similar processes, management and orchestration of certain client layer processes and external integrated services layer processes, various other features and processes management functions.

The external integrated services layer is, in some examples and without imputing undue limitation, an abstraction of various third party services integrated into the IT infrastructure in various ways. For example, and without imputing undue limitation, industry standard security applications, external environment data venders, communications, and other data consumers, producers, and/or third party integrations may be included in the external integrated services layer. The operations layer generally facilitates various developer, administrator, and support operations for the other layers. In some examples, and without imputing undue limitation, system analytics, logging, monitoring and administrator processes may be executed from the operations layer.

In some examples, a user may automatically generate alignments for a new project during or after the project creation flow. The infrastructure layer further includes a stationing and maps orchestrator configured to access project owner data, such as project design specifications, and extract geolocational data, either directly or by inference. The orchestrator may then register the extracted geolocational data to a standard mapping format and converts it to a modular structure suitable for display on a rendered map view of the project site. In some examples, a projection may be retrieved if available and/or if selected by a user during project opening. Projections incorporate various coordinate conversion formulae accounting for the Earth's curvature over distances and thus allow data to accurately register to a flat map view or a linear coordinate system of an area. For example, an alignment may be defined according to the World Geodetic System 1984 (“WGS84”) datum and with points projected to latitude and longitude values consistent with GPS data, while a project may use the Massachusetts State Plane Coordinate System which uses the North American Datum 1983 (“NAD83”) datum and projects points to easting and northing values in U.S. survey feet or meters. In another example, a web-based map may render geographic points based on the Web Mercator projection, which uses a European Petroleum Survey Group datum (“EPSG:3857”) for its projection calculations.

In some examples, the locations of stations are automatically determined and incorporated along the converted alignments in digital form. In the context of this disclosure, stations are markers positioned sequentially and iteratively along a mapped route or alignment. The stations are typically used to identify locations for deliveries, installations, work, and other project deliverables with a degree of relative granularity. While station intervals may be set to any distance, and those interval distances may even vary, 100-foot intervals are most common. Once stations are generated along an alignment, locations along the alignment can be referenced by a combination of one of the two nearest stations, typically the station having the lowest value, and a corresponding offset that describes how many feet away the location is from the station along the alignment. For example, for an alignment that has a starting station with a value of 10 (e.g., station 10), a location 32 feet along the alignment from station 10 may be referred to as 10+32. In some examples, offsets (e.g., mid-points, etc.) between adjacent stations may be further determined and displayed to improve clarity and legibility of stationing along the alignment. Stations are distinct from similar distance markers, such as mile markers on a highway, but can be mapped to mile markers and the like in some examples for greater flexibility in processing and visualization.

In some examples, once the stations are established, electronic tickets for delivered loads, such as asphalt, concrete, gravel, and the like, may be automatically associated with a nearby station at the time of drop off. The associated station may then be used to initiate various downstream functions to do with the delivered electronic ticket. For example, a confirmed and inspected delivery may be compared to the project specifications and payments to contractors and/or vendors disbursed automatically when specifications have been met.

Moreover, in some examples, stations may be associated with deliveries that are either not ticketed, or not ticketed granularly, and reconciled with the project specification data as appropriate. For example, where a project specification dictates that mile marker signs are to be distributed along a stretch of roadway undergoing work, it is often the case that only the bulk delivery of the signs will be tracked and corresponded to a single station. However, in some examples, digital stations may be selected by an inspector in a mobile application whereby the inspector can mark a portion of the mile marker signs bulk ticket as delivered and, furthermore, said delivery note can automatically infer aspects about the partial delivery such as inferring which mile number the sign marks from the corresponding digital station data.

Work zone detection and automations are also implemented in some examples of this disclosure. A work zone, for purposes of this disclosure, is a demarcated geographical area where project-related activities take place, such as a stretch of highway undergoing repaving. Often, when a work zone is determined to be active, heightened traffic conditions go into effect, such as increased fines for traffic violations and/or navigation system alerts notifying users of the activity before they enter the work zone and advising caution. In some examples, work zone activity can be detected and a work zone may be flagged as active and thus activate heightened traffic conditions only for the corresponding work zone area and/or only for as long as activity in the work zones continues. As a result, heightened traffic conditions being unnecessarily activated can be avoided, reducing traffic slow-downs, congestion, and other unnecessary externalities resulting from traffic flows being restricted unnecessarily.

In some examples, work zones may manually be entered through a work zone interface creation and administration interface. Users can manually create work zones by inputting coordinates for start and endpoints of line segments through, for example, an interactable map interface or the like. As or after the coordinates are entered, they may be stored as attributes in a work zone data object, such as the “geolocs” array attribute of the work zone JavaScript Object Notation (“JSON”) of Table 1 below.

In some examples, work zones can be imported directly from alignments as described in this disclosure. Once an alignment has been imported into an alignment data object, such as the alignment JSON of Table 4 further discussed below, a work zone orchestrator may retrieve coordinates from the alignment data object itself, as well as coordinates associated with the alignment's constituent geographic line data (e.g., accessed through the “sequenceid” attribute of Table 4) and/or associated station data objects, such as the example station JSON of Table 3 further discussed below, by retrieving relevant stations (e.g., by querying on a corresponding “alignmentid” and/or “projected” attributes) and extracting locational values therein (e.g., accessed through the “geolocs” array attribute of Table 3).

Having extracted a set of geographic coordinates from the processed alignments, the work zone orchestrator can then, in an example, store those coordinate values in the geolocs array attribute of the corresponding data object. Work zones may then be automatically triggered by equipment signals, registration of ticket deliveries, and other relevant data that provides or enables inference of a geographic position.

In an example, when a possible work zone activity is detected, the geographic position is of the triggering event is determined. An Euclidean distance is calculated between each geoloc attribute in each work zone data object having a corresponding “projectid” attribute and the triggering event's geographic position. The work zone corresponding to the geoloc attribute yielding the smallest value is then identified as the work zone to set into the active state. In some examples, setting a work zone into an active state may be done by modifying a corresponding attribute flag, such as changing the Boolean “active” attribute in Table 1 below from “0” to “1” or the like.

TABLE 1
Example JSON Data Structure for Storing Work Zones

```
{“workzone”: {
  “id”: “332801622”,
  “attributes”: {
    {
    “projectid”: “54321”,
    “geolocs”: [[“x”: ”0123456.012”, “y”: “6543210.987”,
    “z”:  “0114235.001”],  [“x”:  ”0123461.012”,  “y”:
    “6543210.987”,  “z”:  “0114235.001”],  [“x”:
    ”0123461.012”,  “y”:  “6543215.987”,  “z”:
    “0114235.001”]],
    “speed”: “45”,
    “active”: “0”,
    “rules”: [“leonotice”,],
    ...
    }
}}
```

As depicted in Table 1, a work zone record may, in some examples, be implemented as a JSON having a variety of attributes. It is to be understood that Table 1 depicts one example of a storing data structure and that other structures and formats fall within the scope and spirit of this disclosure, such as, for example and without limitation, XML, YAML, HTML, and various other data storage and representation formats. The work zone JSON of Table 1 includes a top level type field, here set to “workzone,” designating the type of data of the record. The “id” field denotes a universal identifier enabling entry into a data store for heterogeneous data structures and “attributes” denotes a series of attributes associated with the record. The “projectid” attribute denotes a unique project with which the record is associated and shared with various other records of potentially different types, as defined, for example, in the type field. The “geolocs” attribute includes an array of coordinate points defined in “x,” “y,” and “z” dimensions. The “speed” attribute denotes the speed to which traffic is to be slowed when the work zone is active, as indicated by the “active” attribute being set to either a “0” or a “1.” The “rules” attribute includes an array of rules identified by name, such as “leonotice,” which may be executed when the record is switched into the active state. Additional attributes may be included in the record, as indicated by the “ . . . ” and as merited by particular projects.

When a work zone is put into the active state, various rules may be triggered into execution. In an example, an attribute, such as “speed” in the JSON of Table 1, may be used to identify a modified speed limit resulting in the work zone being entered into the active state. In some examples, additional rules may be executed on a case-by-case basis. The work zone JSON of Table 1 includes a “rules” array attribute, for example, which includes a “leonotice” value identifying a software script to run that notifies an appropriate law enforcement office that the relevant work zone has become active. Various additional attributes may be included in a work zone data object, on a project-by-project basis according to particularized needs, and the “ . . . ” field of the JSON as depicted in Table 1 is used to indicate the extensible nature of the work zone data object.

In an example, rules for triggering a work zone activation as described above include detecting that a ticket is being dispatched to a project, equipment is detected within a predetermined proximity distance (e.g., 100 feet) of a work zone, and/or detecting that a ticket has been delivered within a predetermined proximity distance of a work zone (e.g., 100 feet). It is to be understood that these are examples of work zone activation rules that may be utilized and should not be taken as exhaustive or unduly limiting.

In some examples, when a digitally registered ticket (e.g., an electronic ticket, an alert that has been sent out for a physical ticket, etc.) describing a delivery to a project is detected, such as a load of asphalt, all work zones associated with the project are switched into the active mode for a predetermined period of time (e.g., three hours) to account for transit time to one of the work zones. Digital tickets include a project identifier, which may be used to run a query a work zone data store for any work zones matching the project identifier (e.g., the projectid of Table 1).

In some examples, when equipment is detected within 100 feet, or other distance as determined by a project owner, of a work zone, the detected equipment may be automatically associated with the work zone's respective project (e.g., the projectid attribute). Subsequently, when the equipment is determined to be in an active state (e.g., engine activity, broadcast activity, etc.), all work zones within one mile, or other distance as determined by the project owner, may be switched into active mode for a predetermined period of time (e.g., three hours).

In some examples, when a digitally registered ticket, such as the one described above, is delivered within 100 feet of a work zone, that work zone may be switched into the active mode, if it is not already in active mode, for a predetermined period of time (e.g., three hours). If the work zone is already in the active mode, then the delivery may instead extend the active mode for an additional hour.

The alignments and stations can be viewed in either a mobile application or a computer application and, depending on view mode, may be interactable to varying degrees. For example, the mobile application may be configured to facilitate inspectors on a work site and thus will allow minimal modification of existing routes and stations, but increased interactions with them such as ticket validation. In contrast, the computer application may provide increased administrative access an allow for finetuned editing of routes and stations, as well as importing new routes and stations. In both cases, viewing of routes and stations is facilitated by a map view with multiple overlays, including aligned drone imagery data which can be toggled on and off. Moreover, in some examples, reports from the mobile application may include facing data, either manually entered or automatically determined relative to a relevant digital station, which details which direction and geolocation a utilizing inspector was facing when submitting report data, such as pictures and the like. Automated alignment and/or registration of drone image data is another operation facilitated by the stations automation and alignments processing of this disclosure. In some examples, the stations are used as anchor points which can provide metes and bounds for anchor boxes defining visual keystone data for aligning imagery. The anchor boxes can be used in addition to, or in lieu of, embedded geolocation data to speed up, increase accuracy, and reduce compute costs of automated drone imagery alignment.

The completed alignments and/or stations can be viewed by project owners or users onsite performing various project tasks. Different views of the alignments are possible, such as differentially toggled views. For those viewing a map with registered alignments on site, the nearest station and offset may be automatically determined and, in some examples, recommended to the onsite user in order to associate an activity record or data upload or the like with an appropriate station. In some examples, the alignment orchestrator can include determining a recommended station contextual information, such as physical proximity of the user to a station, the location of the station relative to other stations and/or alignments, time information, the user's role and/or identification, historical information, and more.

In some examples, completed alignments may be automatically categorized according to a variety of determination techniques, such as reading embedded contextual information in the imported file structure, a rules-based approach applied to various features, and/or a machine learning based approach, among others. In further examples, categorized alignments may be named according to a predefined convention. Table 1 below illustrates an example of a naming regime.

TABLE 2
Horizontal Alignment Naming

| Alignment Type | Naming Convention |
|---|---|
| Mainline | MLRouteNumber |
| Side Road | SRSideRoadName |
| Ramps | RPRampDesignationCrossingRouteName |
| Dike/Levy | DKAdjacentStation |
| Channel | CHCrossingStation |
| Entrance | ENTSideCrossingEvenStation |
| Detour | DETDetourNumber |
| Edge Returns | RETQuadrantSideRoadName |
| Collector | CDRStartingStation |
| Distributor Road | |
| Walls | WALLDescription |
| Survey Chain | SURchainName |

Incongruent sets of stationing values across work sites are a problem that may arise in, for example and without imputing undue limitation, DOT roadway maintenance and/or construction projects. A project may include multiple roads coming to an intersection, such as a rotary or a y-intersection. In another example, a project may include a new roadway or piece of roadway that is extended to connect to an existing roadway. Such cases are typically referred to as “merge” or “tie-in” operations and may result in incongruent or even conflicting station assignments making it challenging to understand and document where personnel, equipment, and/or materials are located when presented using standard station and offset nomenclature (e.g., “10+50”, where “10” is the station number and “+50” denotes a 50 foot offset from station 10, etc.). Stations are typically set sequentially every 100 feet of an alignment.

Stationing mismatches may also occur with single alignments, such as, for example, in cases where alignments and associated stationing values have been re-baselined or reset (e.g., a new survey is conducted and new station values assigned). For example, when a roadway is updated to newer standards or repaired following a natural disaster, stations may need to be reset or the road may need to be re-baselined, resulting in possibly incongruent station values due to old and new stations existing on the same alignment.

Significant confusion, mis-documentation, delays, and error can result from such mismatches, sometimes referred to as discontinuities or breaks in chainage. Accordingly, a “station equation” must be worked out that describes a mode of traversing between the incongruent sets of station values.

$$A + a BACK = B + b AHEAD \qquad ( 1 )$$

Equation 1 above is an example of a station equation format as might be seen in a civil engineering plan document. In equation 1, A and Bare station values related to respective sets of stations, and a and b are offsets indicating where the stationing regimen of A and B respectively begin when traversing in an incrementing fashion along a shared alignment (Back) and when traversing in a decrementing fashion along the shared alignment (Ahead).

Arbitrary values will be used to fill in equation 1 for explanatory purposes. In equation 2 below A is equal to 10, a is equal to 5, Bis equal to 5, and bis equal to 25.

$$10 + 5 BACK == 5 + 25 AHEAD \qquad ( 2 )$$

Effectively, equation 2 defines at which point and in what direction along the alignment or alignments to switch between sets of stations. Operationally, the station equation may be understood as a potentially irregular station. A location along the alignment 50 feet back from the point of the station equation would be labeled 9+55. Likewise, a location 50 feet ahead of the point of the station equation would be labeled 5+75.

In one example of an automated stationing manager software component, the point along an alignment of a station equation may be treated as a station data object. For purposes of clarity and simplicity, this station may be referred to as an equation station in the disclosure below. A dedicated software component may determine the equation station before the stationing manager executes a procedure for determining intermediate station locations along the corresponding alignment or alignments. Offsets can be incorporated directly into the positioning of the equation station along the alignment(s). The stationing manager may first populate the alignment with stations from a starting station and along the alignment preceding the equation station through a first sweep of the stationing procedure, and then perform a second sweep of the stationing procedure beginning from the equation station and to an ending station along the remainder of the alignment(s). In this approach, the station equation is digitized as a station data point and possibly complex ad hoc calculations can be avoided, enabling easier caching (e.g., if station locations need to be displayed on a device that will leave network service coverage) and a compute chain that is less susceptible to failure points (e.g., fewer computations are necessary for retrieving stationing data to a device).

In some examples, alignments and/or stationing may be digitized in modes that do not provide relative positioning. For example, while the Industry Foundation Classes (IFC) standard, an open and international standard for describing constructed environments such as civil infrastructure and buildings, includes a data structure adapted to stations that includes relative positioning with regard to associated alignments, it is also commonly the case with IFC models for stations to be stored and managed within a generic data structure storing just a geolocational coordinate position and station value as attributes (i.e., not including relative positioning with regard to the associated alignment(s)). When handling stations that are stored and maintained in such a manner, generating a station equation requires calculating offsets based on a shared geographic reference point.

Accordingly, in some examples of an automated stationing manager software component, a station equation can be calculated and then applied in order to tie multiple chainages, or sets of stationing, together. An offset between a selected back station and a forward station value is calculated that corresponds to a common geographic location to maintain continuous numeric stationing across the one or more alignments, and that calculated offset is then applied to generate and store the common geographic point. The resultant continuity correction ensures that subsequent station values remain consistent in both numeric sequence and geographic position.

In some examples, alignments and stations may be structured as independent data structures. Alignments may be stored in a database as records in an alignments table and stations may likewise be stored as records in a stations table. In such a storage configuration, station equations may be maintained as stored station records with a station equation attribute. Other station attributes may be, for example, a default empty value indicating an intermediary station, a start station attribute, and/or an end station attribute. A geolocation attribute may then be used to ensure stations are located at their respective intended locations along a corresponding alignment. Additionally, a project key may be included as an attribute and used to later retrieve relevant station data. When continuity adjustments are required, a previously stored station-equation record may be retrieved from the project database by project identifier (e.g., projectid) and/or the alignment identifier (e.g., alignmentid). The retrieved record is then reapplied by the stationing manager or equivalent software module to reconcile discontinuities and maintain consistent stationing and rendering of positional data across one or more alignments.

TABLE 3
Example JSON Data Structure for Storing Stations

```
{“station”: {
  “id”: “123456789”,
  “attributes”: {
    {
    “projectid”: “54321”,
    “alignmentid”: “029-GEO-0210”,
    “geoloc”: [“x”: “0123456.012”, “y”: “6543210.987”, “z”:
    “0114235.001”],
    “type”: “start”,
    “measure”: “0”,
    “staval”: “0”,
    “offset”: “0”,
    “ahead”: “1”
    }
}}
```

As depicted in Table 3, a station record may, in some examples, be implemented as a JSON having a variety of attributes. It is to be understood that Table 3 depicts one example of a storing data structure and that other structures and formats fall within the scope and spirit of this disclosure, such as, for example and without limitation, XML, YAML, HTML, and various other data storage and representation formats. The station JSON of Table 3 includes a top level type field, here set to “station,” designating the type of data of the record. The “id” field denotes a universal identifier enabling entry into a data store for heterogeneous data structures and “attributes” denotes a series of attributes associated with the record.

The “projectid” attribute denotes a unique project with which the record is associated and shared with various other records of potentially different types, as defined, for example, in the type field. The “alignmentid” attribute denotes the unique alignment with which this station record is associated. The “geoloc” attribute includes an array storing “x,” “y,” and “z” coordinates that geographically pinpoint the station of the record. Unlike the geoloc attribute of the work zone record described above in Table 1 or the alignment record described below in Table 4, the geoloc attribute of the station record includes only a single array of coordinates. While a three-tuple is depicted as the atomic coordinate structure used for the respective geolocational attributes in Tables 1, 3, and 4, discussed below, it is to be understood that the configuration of the coordinates structure may vary from project to project, as called for by the respective projection and/or datum used by the particular project. The “type” attribute denotes to what type of station the record is related. In some examples, the type attribute may be set to one of “start,” “end,” “equation,” or “standard” according to whether the station is at the start of an alignment, end of an alignment, serves as a station equation as described above, or is standard station distributed between the other station types along an alignment. The “measure” attribute denotes how many units, typically feet, along the alignment at which the corresponding station is located. The “staval” attribute denotes the station value and is typically a whole number following a rubric as described above in regards to station numbering and sequencing. The “offset” attribute stores any offset value that may be needed to determine the next station placement in the stationing sequence and is generally only use in relation to equation stations. The “ahead” attribute identifies whether the station is associated with an increment along the alignment (e.g., moving in the primary direction of orientation along the alignment) and, as depicted in the example of Table 3, is a Boolean operator. When ahead is set to “0,” the station may be understood to be a back station and associated with a decrement along the alignment. Most station records of all types are oriented ahead (e.g., ahead is set to “1”).

In some cases, station equations may need to be retrieved after stationing has been performed. In such situations, in some examples, stations equations may be stored as individual attributes or records within a project database. The station equation records may, in such cases, include attributes identifying projection parameters and coordinate reference system as appropriate. In some examples, the station equation may be recreated upon request based on the attributes of the equation station record described above. BACK and AHEAD values, and respective offsets, can be derived from the position of the equation station along an alignment relative to other stations on the same alignment, and the projection and coordinate parameters may be retrieved from the associated project data store based on the projectid attribute value, or the like.

Alignment records may likewise include geolocation attributes and project keys for positioning and retrieving. In some examples, the geolocation attributes may be starting and ending points of the respective alignment. Shape or geometry data may then be stored as additional attributes.

In effect, a project key can be used to retrieve all station and alignments data for a project, which will respectively include geolocational mappings for accurately rendering on a mobile device display, for example. Moreover, geolocational data from the device may be used to further filter the query results to include only relevant station and alignment (e.g., within a predetermined geographic proximity, etc.).

TABLE 4
Example JSON Data Structure for Storing Alignments

```
{“alignment”: {
  “id”: “876543210”,
  “attributes”: {
    {
    “projectid”: “54321”,
    “alignmentid”: “029-GEO-0210”,
    “start”: [“x”: “0123456.012”, “y”: “6543210.987”, “z”:
    “0114235.001”],
    “end”: [“x”: ”0123451.510”, “y”: “6543208.542”, “z”:
    “0114235.001”],
    “type”: “mainline”,
    “measure”: “1223.58”,
    “sequenceid”: “sdfs4512dfs54dg4522b”,
    }
}}
```

As depicted in Table 4, an alignment record may, in some examples, be implemented as a JSON having a variety of attributes. It is to be understood that Table 4 depicts one example of a storing data structure and that other structures and formats fall within the scope and spirit of this disclosure, such as, for example and without limitation, XML, YAML, HTML, and various other data storage and representation formats. The alignment JSON of Table 4 includes a top level type field, here set to “alignment,” designating the type of data of the record. The “id” field denotes a universal identifier enabling entry into a data store for heterogeneous data structures and “attributes” denotes a series of attributes associated with the record.

The “projectid” attribute of Table 4 denotes a project with which the recorded alignment is associated. The “alignmentid” attribute provides a unique identifier for the specific alignment of record and, in some examples, can be used to associate various other data with the alignment, such as station records, etc. The “start” and “end” attributes each include a respective array storing “x,” “y,” and “z” coordinates that geographically pinpoint the starting point and ending point of the alignment of record. In some examples, either or both of these attributes may be used to place initial stations in association with the alignment of record. The “type” identifies what kind of alignment is indicated by the record. In some examples, types may correspond to the naming conventions of Table 2 discussed above. The “measure” attribute stores the total linear length of the alignment in the unit of choice for the corresponding project (e.g., feet, meters, etc.). The “sequenceid” attribute denotes an ordered sequence of line component geometries connecting the start and end attributes to each other to form the complete alignment. In some examples, the sequenceid may reference another data object. In some examples, the sequenceid may encode the geometries directly into a string using a compression algorithm.

In some examples, the stationing and alignments processes described above can be applied to export and import functionality for physical plan documents. Exporting stationed alignments to a printed out plan document may be performed by applying a style transfer to a map view of a set of stationed alignments or rendering the view in the preferred print out style. In comparison, importing markup from plans written by hand may require execution of the various processes described above after preprocessing is performed of an image of printed out plan intended to be imported.

In some cases, inspectors, plan managers, and others working on a project may prefer a physical print out of a project plan on which to make handwritten notes and edits. This may be especially preferred when an onsite presence is needed to make the edits and the project site is in a location with poor network or no network connectivity. However, manually transferring the annotated plan document into a digital plan management system may be tedious and prone to error and/or inconsistencies. Accordingly, in some examples, users may create a digital image of the plan by scanning or taking a photograph of the marked up document.

The plan image may then be uploaded to a project database and associated with the corresponding project and alignments and stations displayed. The association may be entered manually or by including embedded indicators in the exported document, such as watermarks, QR codes, bar codes, or the like. A computer vision module may then identify the visual elements associated with the document and the visual elements that have been added.

Certain element geometries and configurations can be associated with further processing to be done by the project management service. For example, lines cross hatching an existing alignment may indicate deletion of a corresponding segment and/or an added line with ticks and new station identifiers may indicate an additional alignment. When a new alignment addition is detected, start and end geographic points may be calculated based on positioning of the markup on the document, the project scope, and contextual features like area terrain and existing alignments. The line path can be determined using the same factors. Additional data relevant to the creation of the alignment and stationing using the processes above may extracted from the uploaded image as well, such as various station values and/or a station equation, such as in the case where a merger operation is depicted by the markup. Once these data items are determined, the digital alignment and stationing discussed above can be applied to fully integrate the markup into the digital project files.

Moreover, any of the steps, operations, processes, executions, and the like described in relation to examples described below can be accomplished by a specific-purpose computer system or general-purpose computer system, or a computer-readable medium, or data carrier system configured to carry out any of the steps described. The computer system can include a set of software instructions that can be executed to cause the computer system to perform any of the methods or computer-based functions disclosed herein. The computer system may operate as a standalone device or may be connected, for example using a network, to other computer systems or peripheral devices. As an example, a computer system performs logical processing based on digital signals received via an analogue-to-digital converter.

Some portions of the description are presented in terms of symbolic representations of operations on non-transient signals stored within a computer memory. These descriptions and representations are used by those skilled in the art to convey the substance of their work most effectively to others. Such operations typically require physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulation of physical quantities as modules or code devices, without loss of generality.

All of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (e.g., electronic) quantities within the computer system memories or registers or other such information storage components. Portions of the present disclosure include processes and instructions that may be embodied in software, firmware, or hardware, and when embodied in software, may be downloaded to reside on and be operated from different platforms used by a variety of operating systems.

In a networked deployment, the computer system may operate in the capacity of a server, or as a client user computer in a server-client user network environment, or as a peer computer system in a peer-to-peer or distributed network environment. The computer system can also be implemented as or incorporated into various devices, such as a server or another type of computer such as a workstation that includes a controller, a stationary computer, a mobile computer, a personal computer (PC), a laptop computer, a tablet computer, or any other machine capable of executing a set of software instructions sequentially or non-sequentially that specify actions to be taken by that machine. The computer system can be incorporated as an integrated system part of a larger system that includes additional devices. For example, the computer system can be implemented using one or more electronic devices that provide voice, video, or data communication possibilities. Further, while the computer system is illustrated in the singular, the term “system” may include any collection of systems or sub-systems that individually or jointly execute one or more sets of software instructions to perform one or more computer functions.

The computer system may also include one or more processors. The processor executes instructions to implement some or all aspects of methods and processes described herein. The processor is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor is an article of manufacture and/or a machine component.

The processor is configured to execute software instructions to perform functions as described in the various examples herein. The processor may be a general-purpose processor or may be part of an application specific integrated circuit (ASIC). The processor may also be a microprocessor, a microcomputer, a processor chip, a controller, a microcontroller, a digital signal processor (DSP), a state machine, or a programmable logic device, a logical circuit, including a programmable gate array (PGA), such as a field programmable gate array (FPGA), or another type of circuit that includes discrete gate and/or transistor logic. The processor may be a central processing unit (CPU), a graphics processing unit (GPU), or both. Additionally, any processor described herein may include multiple processors, parallel processors, or both. Multiple processors may be included in, or coupled to, a single device or multiple devices. The processor can include one or more internal levels of cache, and a bus controller or bus interface unit to direct interaction with a bus. The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection, or network, of computing devices each including a processor or processors. Programs have software instructions that can be performed by one or multiple processors that may be within the same computing device or which may be distributed across multiple computing devices. Further, the software instructions, when executed by the processor, perform one or more steps of the methods and processes as described herein.

Turning to further description, reference is made to the drawings of some implementations of the disclosure provided above. It is to be understood that the following disclosure is for explanatory purposes and should not be taken to be unduly limiting. Variations, iterations, and modifications of the described examples are possible while remaining within the scope of the disclosed invention.

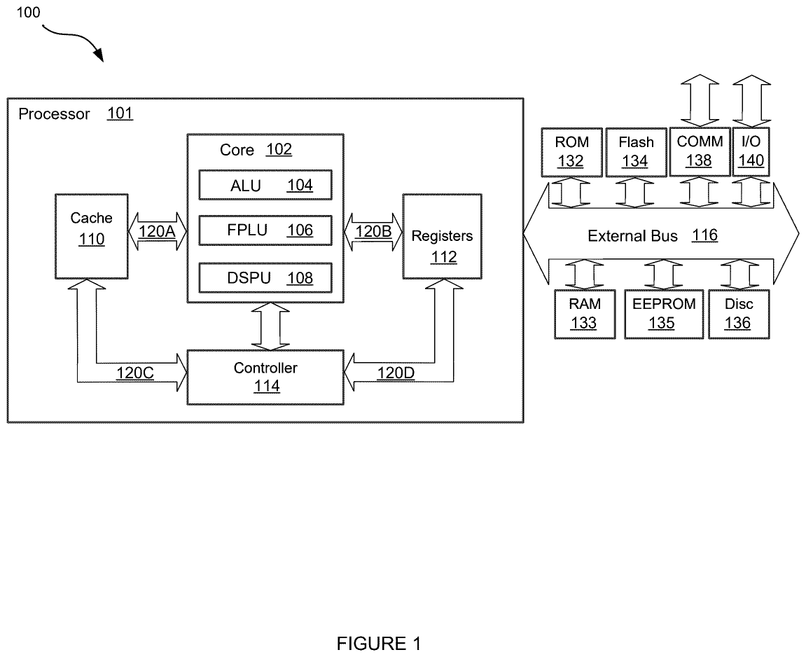

FIG. 1 depicts a block diagram illustrating an exemplary computer system 100 according to examples of the disclosure. Computer system 100 may include a processor 101 for implementing one or more processors described herein. Processor 101 may be any suitable processor type including, but not limited to, a microprocessor, a microcontroller, a digital signal processor (DSP), a field programmable array (FPGA) where the FPGA has been programmed to form a processor, a graphical processing unit (GPU), an application specific circuit (ASIC) where the ASIC has been designed to form a processor, or a combination thereof.

Processor 101 may include one or more cores 102. Core 102 may include one or more arithmetic logic units (ALU) 104. In some examples, core 102 may include a floating point logic unit (FPLU) 106 and/or a digital signal processing unit (DSPU) 108 in addition to, or instead of, ALU 104.

Processor 101 may include one or more registers 112 communicatively coupled to core 102. Registers 112 may be implemented using dedicated logic gate circuits (e.g., flip-flops) and/or any memory technology. In some embodiments registers 112 may be implemented using static memory. The register may provide data, instructions and addresses to core 102.

In some examples, processor 101 may include one or more levels of cache memory 110 communicatively coupled to core 102. Cache memory 110 may provide computer-readable instructions to core 102 for execution. Cache memory 110 may provide data for processing by core 102. In some embodiments, the computer-readable instructions may have been provided to cache memory 110 by a local memory, for example, local memory attached to external bus 116. Cache memory 110 may be implemented with any suitable cache memory type, for example, metal-oxide semiconductor (MOS) memory such as static random access memory (SRAM), dynamic random access memory (DRAM), and/or any other suitable memory technology.

Processor 101 may include a controller 114, which may control input to processor 101 from other processors and/or components included in a system and/or outputs from processor 100 to other processors and/or components included in the system. Controller 114 may control the data paths in ALU 104, FPLU 106, and/or DSPU 108. Controller 114 may be implemented as one or more state machines, data paths, and/or dedicated control logic. The gates of controller 114 may be implemented as standalone gates, FPGA, ASIC or any other suitable technology.

Registers 112 and cache memory 110 may communicate with controller 114 and core 102 via internal connections 120A, 120B, 120C, and 120D. Internal connections may be implemented as a bus, multiplexor, crossbar switch, and/or any other suitable connection technology.

Inputs and outputs for processor 100 may be provided via a bus 116, which may include one or more conductive lines. Bus 116 may be communicatively coupled to one or more components of processor 101, for example controller 114, cache memory 110, and/or register 112. Bus 116 may be coupled to one or more components of the system.

Bus 116 may be coupled to one or more external memories. The external memories may include read only memory (ROM) 132. ROM 132 may be a masked ROM electronically programmable read only memory (EPROM), or any other suitable technology. The external memory may include random access memory (RAM) 133. RAM X33 may be a static RAM, battery backed up static RAM, Dynamic RAM (DRAM), or any other suitable technology. The external memory may include Electrically Erasable Programmable Read Only Memory (EEPROM) 135. The external memory may include Flash memory 134. The external memory may include a magnetic storage device such as disc 136. In some examples, the external memories may be included in a system.

In some examples, bus 116 may include a communications interface 138 by way of which computer system 100 can connect to networks and receive data useful in executing the methods and system set out herein as well as transmitting information to other devices. Computer system 100 may further include an input/output (IO) interface 140 for communicatively accessing connected devices. The connected devices may include a video display unit such as a liquid crystal display (LCD), an organic light emitting diode (OLED) display, a flat panel display, a solid-state display, or a cathode ray tube (CRT), and/or any other suitable technology. The connected devices may further include input devices such as a keyboard/virtual keyboard, touch-sensitive input screen, speech input with speech recognition, and/or a cursor control device such as a mouse or touch-sensitive input screen or pad, and/or other suitable technologies. The connected devices may also optionally include a disk drive unit, a signal generation device such as a speaker or remote control, an external network interface device, and/or other suitable technologies.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any programming language that is sufficient for achieving the techniques and implementations of the present disclosure may be used. In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In accordance with various embodiments of the present disclosure, the methods described herein may be implemented using a hardware computer system that executes software programs. Further, exemplary implementations can include distributed processing, component/object distributed processing, and parallel processing. Virtual computer system processing may implement one or more of the methods or functionalities as described herein, and a processor described herein may be used to support a virtual processing environment.

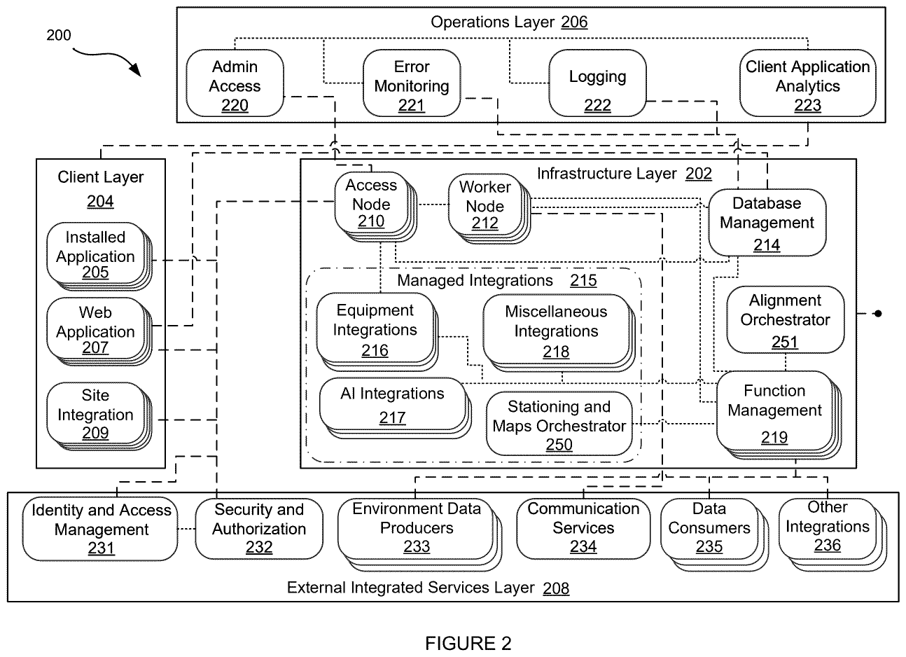

FIG. 2 depicts a supporting infrastructure 200 in diagrammatic form according to examples of the disclosure. Supporting infrastructure 200 may include an operations layer (OL) 206, a client layer (CL) 204, an external integrated services layer (EISL) 208, and an infrastructure layer (IL) 202. It is to be understood that the layers depict logical abstractions and do not necessarily coincide with, for example, shared physical locations for component execution or offering. Rather, the layers of supporting infrastructure 200 group infrastructure components by purpose and the types of access to infrastructure components correspondent to the respective layer. CL 204 generally includes the modes by which end users engage with products and services hosted by supporting infrastructure 200 while IL 202 generally includes the primary functions and operations underpinning those hosted products and services. EISL 208 generally includes external services and integrations which either support IL 202 operations or consume data from IL 202 operations.

CL 204 may include one or more installed applications 205, one or more web applications 207, and one or more site integrations 209. Installed applications 205 include, for example and without imputing undue limitation, software installed to a computing device or computer, including in some examples personal computers, laptop computer, wearables, and mobile devices, such as smart phones, tablets, and the like. Web applications 207 includes software primarily accessed through an internet browser application, which may be executed in whole or in part on either or both a local computer and a hosted computer. Site integrations 209 may include automations integrated into a location's own IT infrastructure and may also include direct or indirect integrations of on-site hardware, such as through on-device installations or via middleware installed into the location's IT infrastructure. The automations and integrations of site integrations 209 enable data flows between IL 202 and the respective site.

Each component of CL 204 (e.g., installed applications 205, web applications 207, site integrations 209, etc.) interfaces with IL 202 via an access node 210. Access node 210 is a scalable hosted process extended as a public IP endpoint. Access node 210 may serve as the target entry point for all end users attempting to interface with IL 202. For example, access node 210 can be addressable via internet protocol (IP) address over the internet. In some examples, access node 210 enforces a format requirement upon received data before further dispatching appropriate services and/or functions within IL 202. The format may be a JavaScript Object Notation (JSON) data object with predefined fields including, for example, authentication and account identification fields, contents fields, and validation fields. Based on the components of the JSON authentication and account identification fields (e.g., prefixed information, suffixed information, flags, etc.), access node 210 may determine which content format to expect and to which IL 202 components to dispatch the incoming data. For example, digital ticket data may include a corresponding flag in its authentication and account identification field and, as a result, access node 210 may check to see whether the corresponding JSON includes an indicator of what type of digital ticket implementation to expect and which fields and in what format those fields can be expected (e.g., a predefined particular vendor format, a site specific format, a generic format, etc.).

IL 202 includes various orchestration and operational processes, in addition to access node 210 as described above, which enable various features made available to users. Based on the received data, access node 210 may deploy or invoke an appropriate worker node 212. Multiple worker nodes 212 may be instantiated by the same access node 210 or other access nodes 210 and each of these additional worker nodes 212 may perform the same or different operations. Worker node 212 is a generalized function or process that may be executed within IL 202 (e.g., by or on a server to which at least some portion of IL 202 is deployed) to perform various features provided to users either via client layer 204 or otherwise, and the specific operations and interactions performed by worker node 212 is determined by data received by corresponding access node 210. In general, worker node 212 will invoke one or more of function management 219, database management 214, and/or communications services 234. Here, communications services 234 is an integrated external service in EISL 208; however, in other examples, communications services 234 may be wholly or entirely a native service run in IL 202 generally or among managed integrations 215. Function management 219 is a generalized function or process that may be executed within IL 202 to perform various processes as needed by worker node 212, including for example interfacing with database management 214, managed integrations 215, and/or EISL 208. Managed integrations 215 may include equipment integrations 216, AI integrations 217, and miscellaneous integrations 218, which are included to represent the general extensibility of the architecture of IL 202. Among managed integrations 215, equipment integrations 216 may also directly interface with access node 210 in order to, for example, perform automated database operations via a corresponding worker node 212 interfacing with database management 214, such as in the case of automated tracking of equipment of on a job site.

In some examples, equipment integrations 216 may include a channel for sensor data, such as from construction equipment, to be received from the field or intermediary services such as manufacturer portals and the like. Sensor data may include raw or processed data generated by either or both manufacturers or aftermarket devices installed to construction equipment. Examples include, without undue limitation, engine controller area network (CAN) bus outputs, GNSS, inertial measurement units, sonic or laser elevation sensors, camera-based grading systems, etc.

EISL 208 is an abstraction of services and processes that support or are supported by processes and functions otherwise executed by IL 202. The services and processes within EISL 208 include infrastructure operations, such as identity and access management (IAM) 231 and security and authorization (SaA) 232, which respectively facilitate user login and manage user access to various services and processes enabled by supporting infrastructure 200. While IAM 231 and SaA 232 are depicted in FIG. 2 as communicating between each other directly, it is understood that other configurations not depicted here are nonetheless disclosed, such as managing correspondence of IAM 231 and SaA 232 via IL 202 or CL 204, or as a merged monolith service, as two non-limiting examples. In some examples, IAM 231 and SaA 232 interface with both CL 204 components and respective access nodes 210 to ensure secure and authenticated interaction between CL 204 and IL 202. Other infrastructure operations that may be included within EISL 208 include communication services 234, which may include email, text messaging, phone call, voice over IP (VOIP), and other human interpretable communications and/or alerts.

EISL 208 may additionally include environment data producers (EDPs) 233 and data consumers 235. EDPs 233 includes abroad range of external services such as mapping, weather, Light Detection and Ranging (LIDAR), vehicle, and other services producing data that may be integrated into a project management system. Accordingly, individual EDPs 233 may require unique or customized integrations, which may be managed and executed function management 219. Data consumers 235 also encompasses a broad range of services such as traffic management, mapping, various regulatory oversight, and other services that may consume data produced by IL 202 for respective purposes. Likewise, individual data consumers 235 may require unique or customized formats and/or protocols, which may be managed and executed by function management 219. EISL 208 further includes other integrations 236, which is abstracts the extensibility of EISL 208 and may be managed on IL 202 through function management 219 accordingly.

OL 206 represents the developer and IT operations features for interfacing and modifying various aspects of supporting infrastructure 200 across each of IL 202, CL 204, and in some examples EISL 208. Generally, OL 206 is not accessible by external users, such as customers utilizing components of CL 204. Admin access 220 encompasses an access profile to IL 202 that allows a user to view and/or modify records associated with end users (e.g., those interfacing with IL 202 primarily through CL 204), such as individual project files and the like. In some examples, admin access 220 undergoes a separate identification, authorization, and security process than those provided by IAM 231 and SaA 232. Error monitoring 221 interfaces with database management 214 and identifies errors that arise in either IL 202 operations or CL 204 operations, such as erroneous project changes or issues with an interface component of an installed application 205. Error monitoring 221 may maintain an error log for later review or may, in some examples, generate an alert. In some examples, logging 222 may include the error among its other functions. Logging 222 may further include activity and process logging. Error logging 222 performs activity and process logging by maintaining a database or other record of activities performed by IL 202, such as database read and write operations, retrievals of external data, user log-ins, and the like. Client application analytics 223 monitors and maintains a record of statistical information on CL 204, such as number of application downloads, account creations, download locations, and the like. In some examples, client application analytics 223 may further include maintaining a record of user interactions at CL 204, such as mouse movements, screen changes, etc. Admin access 220, error monitoring 221, logging 222, and client applications analytics 223 all directly intercommunicate, and in some examples the latter three components of OL 206 may only be accessed and their corresponding records viewed through admin access 220.

Here, IL 202 further includes alignment orchestrator 251, which interacts with function management 219. Alignment orchestrator 251 may receive and handle requests for generating data related to alignments and route creation. Stationing and maps orchestrator 250 handles various functions to do with stations and maps, such as generating stations along a route, recommending stations which may be associated with processed digital tickets, retrieving map data for rendering and interaction in routes, stations, and work zones interactive screens, and processing work zone automations. Generated alignments, stations, and accepted station associations, such as by onsite inspectors, workers, etc., are forwarded to database management 214 for storage and ongoing access and/or updates. Alignment orchestrator 251 and stationing and maps orchestrator 250 may respectively retrieve various data via function management 219, such as project data from database management 214, geolocation data from CL 204, contextual environment data from EDPs 233, and more.

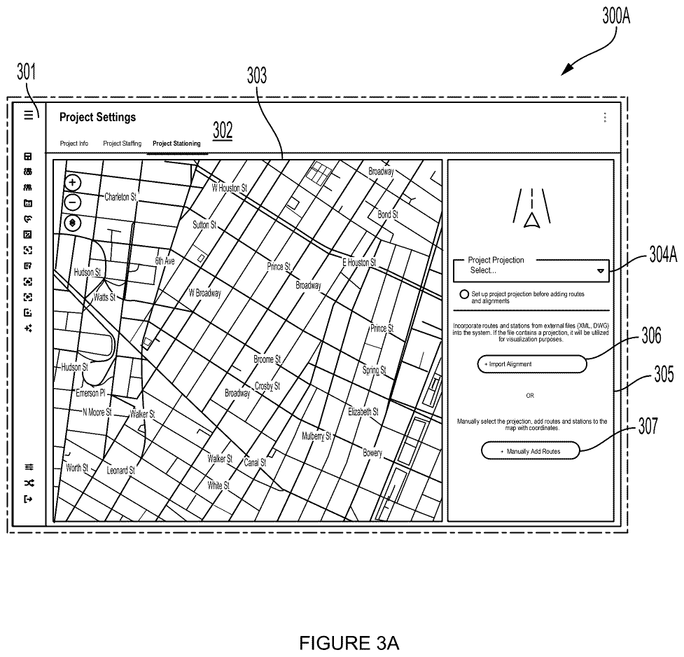

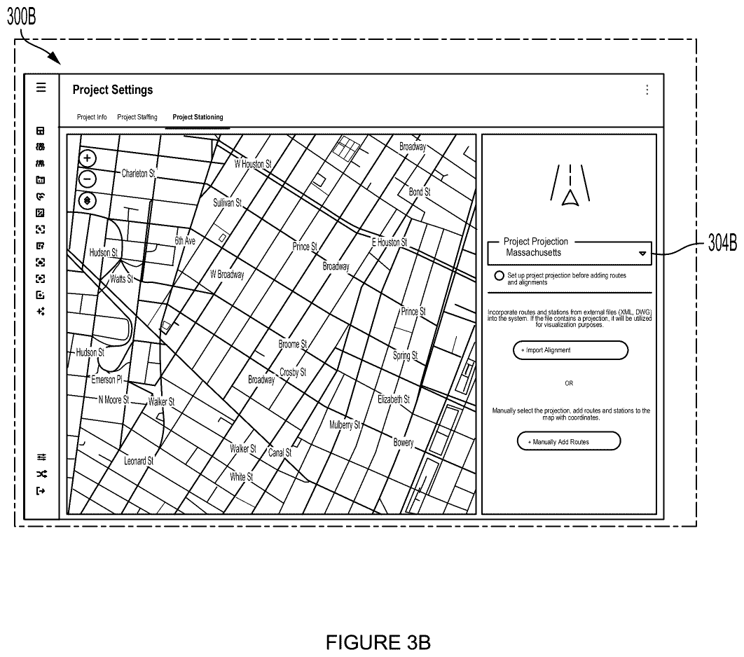

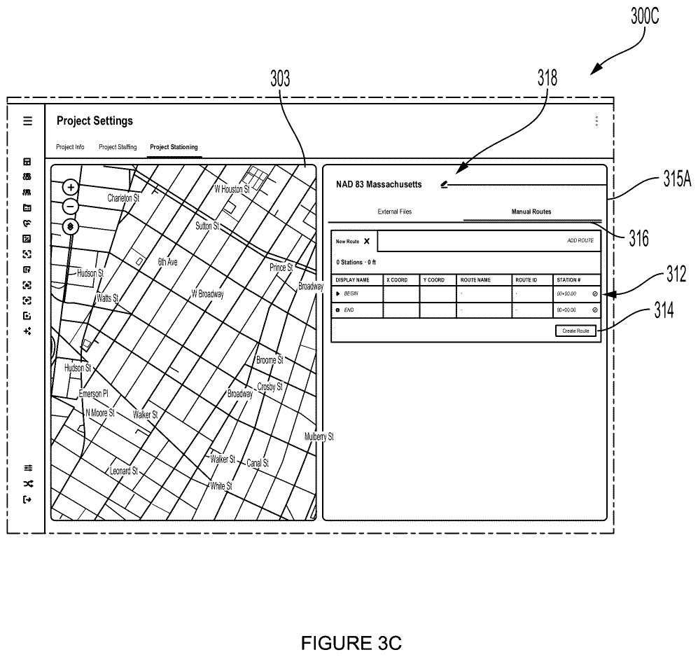

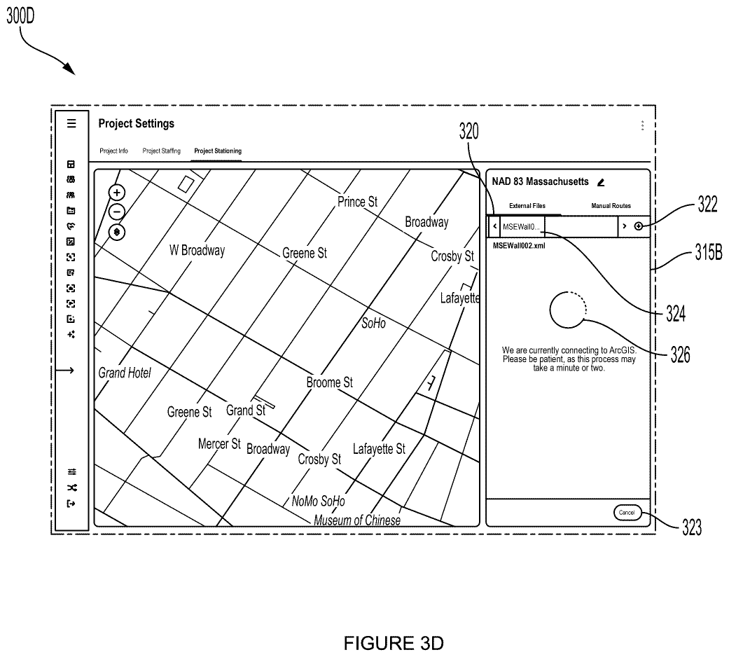

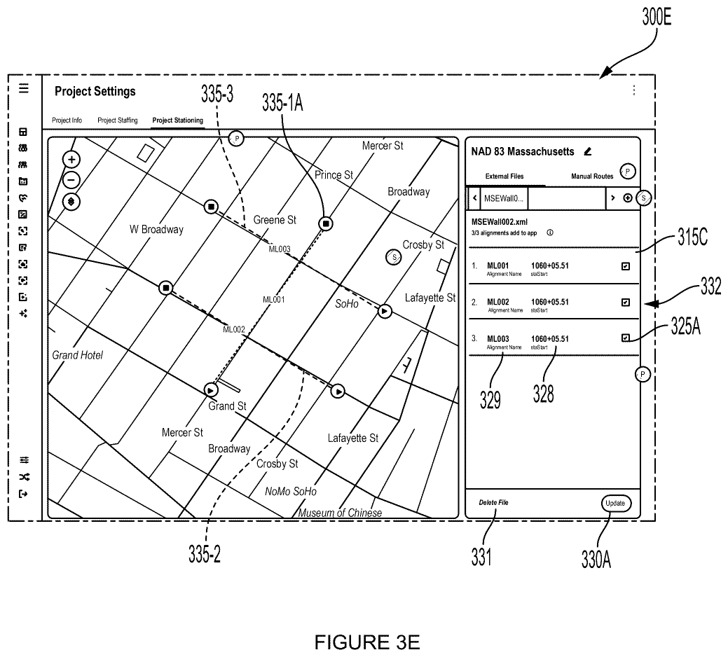

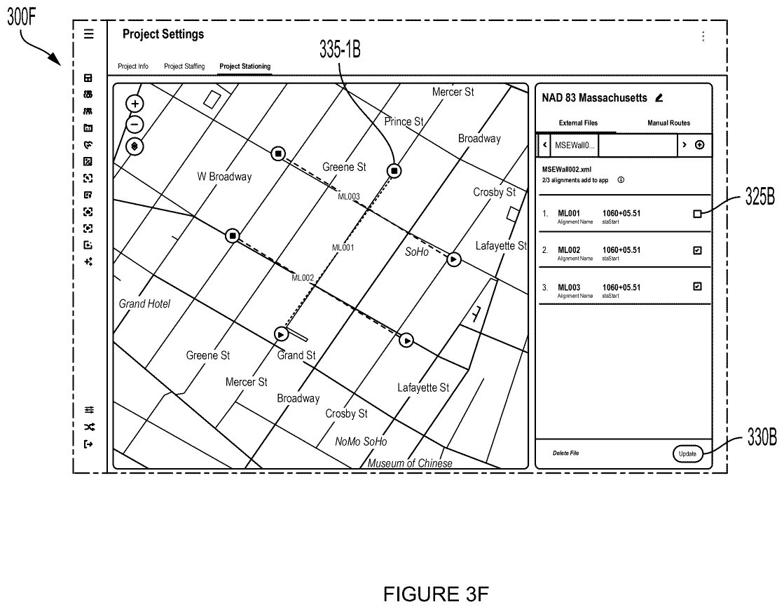

FIGS. 3A-F depict an example of a project stationing tab of a project settings screen 302 as it is navigated through views 300A-F by which stationed routes for a project are created. Project settings screen 302 may be accessed from a PC by web browser and, as depicted here, is embedded into a larger web application providing analytics, staffing, administrative, and other features for DOT project management. For example, additional features may be navigated to by clicking on icons in navigation pane 301.

In view 300A, the stationing tab of project settings screen 302 includes a map module 303 beside a new project pane 305. Map module 303 persists through views 300A-F, providing a responsive and interactive map view showing and enabling the creation of routes. As depicted in FIG. 3A, new project pane 305 includes a projection selector 304A, alignment importer selector 306, and manual route creation selector 307.

As described above, some states may employ various mathematical projections that enable mapping of coordinates related to project planning, such as route locations, from one coordinate system to another, often accounting for the earth's curvature and/or other topographical effects upon a planar coordinate system. Projection selector 304A is structured as a drop down tab which a user may interact with to select one of potentially multiple projection options accessible to them for the respective project. The projection options are provided by a corresponding project owner, such as a state DOT. In some examples, the project owner may maintain a set of projections on their own server and projection selector 304A may be populated by querying the project owner server. Each station-equation record stores or inherits the coordinate-reference and projection parameters of its associated alignment, such as the World Geodetic System 1984 (WGS84, EPSG:4326), the Massachusetts State Plane Coordinate System, NAD83 (EPSG:26986), or the Web Mercator projection (EPSG:3857), to ensure that all station-to-map conversions remain geospatially consistent within the defined mapping standard.

FIG. 3B depicts view 300B similarly to 300A except that it includes a valid projection selection having been selected in projection selector 304B. With a valid projection selected, a route creation method may then be selected. If alignment importer selector 306 is selected, the user will be guided through view 300C. If alignment importer selector 306 is selected, the user will be guided through views 300D-F. In both instances, a valid projection must be selected in projection selector 304A to proceed.

In FIG. 3C, view 300C includes map module 303 and route creation pane 315A. The user may set a name for a new route in an editable route name field 318. Here, route creation pane 315A is set to manual routes tab 316, which includes new route table 312. New route table 312 provides a tabular view of points defining the new route, with each row representing a distinct point. Points may be added to the route by interacting with map module 303 via mouse click. As can be seen in FIG. 3C, a route point may be designated in a display name cell of route table 312 as a BEGIN point or END point. Not depicted, but disclosed herein, are generic route points which may be designated with other names.

Nevertheless, each route must have respective BEGIN and END points designated. In some examples, work zones alerts and the like are associated with proximity to a BEGIN route point and/or station. In some examples, routes may be automatically stored with an inverted copy of the route swapping BEGIN and END points, so that navigation services consuming the data can trigger proximity alerts for vehicles entering a work zone in either direction appropriately.

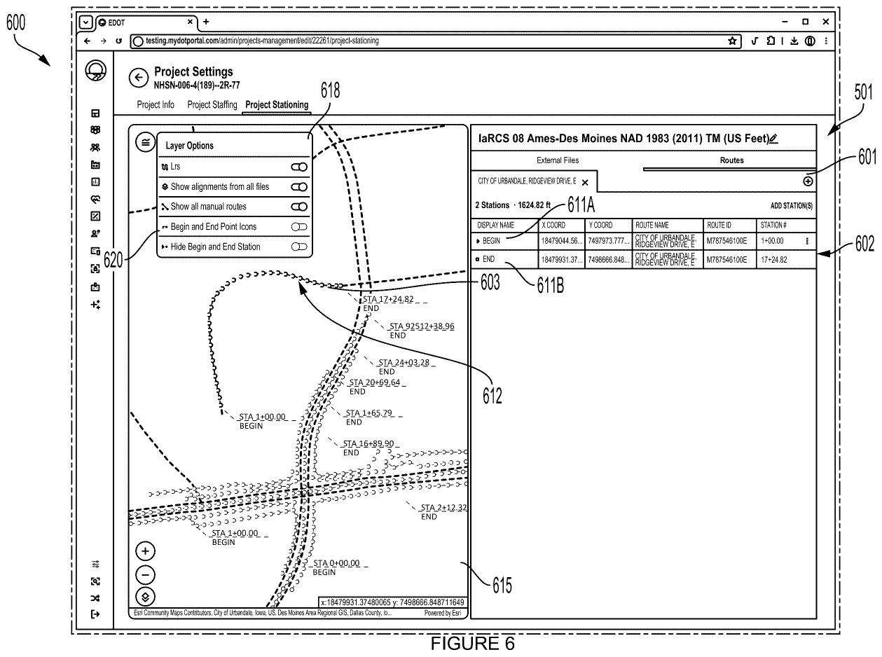

Once relevant points of the route have been entered, the user may interact with a create route button 314 to cause the system to generate connecting edges between the points, thus defining a suggested final route. Referring briefly to FIG. 6, a resultant finalized manual route 603 corresponding to manually entered points 611A-B in a route table 602 is shown in view 600, which includes a map module 615. In particular, manual route 603 further includes automatically generated stations 612. Stations 612 are automatically generated as a result of interacting with create route button 314 and are consistently interleaved between entered points based on a customizable distance value. For example, as depicted in FIG. 6, stations 612 are spaced every 50 feet. In other examples, stations may be spaced every 100 feet, every 10 feet, or otherwise, as preferred by the user. Once a route and its stationing have been validated or updated by a user, they are saved for later access and interaction by either or both mobile or web application modalities.

Referring now to FIG. 3D, view 300D is of a flow responsive to a user selecting alignment importer 306 rather than manual route creator 307 discussed above. View 300D includes an external files tab 320 of route creation pane 315B. File selector 322 allows for a user to identify an alignments file external to the project and select it for import. Once selected, action button 323 may be interacted with to initiate the external alignments file being uploaded to the hosting server and where routes may be extracted from it. A progress meter 326 in interior space of route creation pane 315B indicates how much of the import task has been completed and how much remains. While an external alignment file is being imported, action button 323 switches to a cancel state, whereby interactions will abruptly cancel the alignments processing.

FIG. 3E shows view 300E featuring the output of the alignments importation process of FIG. 3D discussed above. View 300E includes a route creation pane 315C in which progress meter 326 has been replaced with an imported routes table 332. Here, imported routes table 332 includes three routes corresponding to respective rows. Each row entry includes a route name 329, route station information 328, and a route display selector 325A. The route entries in imported routes table 332 further correspond to mapped routes 335-1A, 335-2, 335-2.

As can be seen in subsequent FIG. 3F depicting view 300F, when a route selector is switched to an empty state, such as with route selector 325B, the corresponding mapped route is deactivated, such as with mapped route 335-1B. The display state may then be updated by interacting with update button 330B, which converts from an non-interactable update button 330A into an interactable state when components of route creation pane 315C have been changed. In such a case, the deactivated route will not be shown on mobile devices or other views in the web application. Returning briefly to FIG. 3E, a delete file button 331 may be interacted with to delete the file entirely if, e.g., the user is not satisfied with the imported alignments.

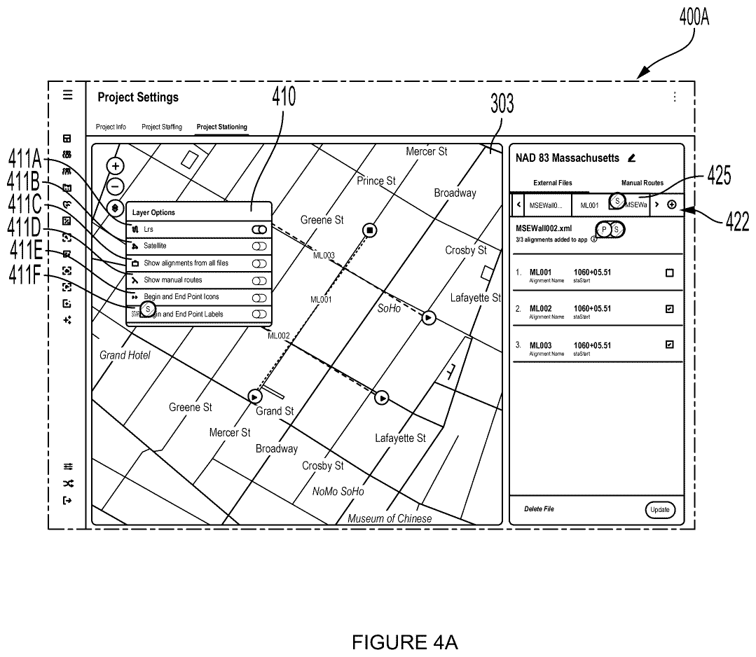

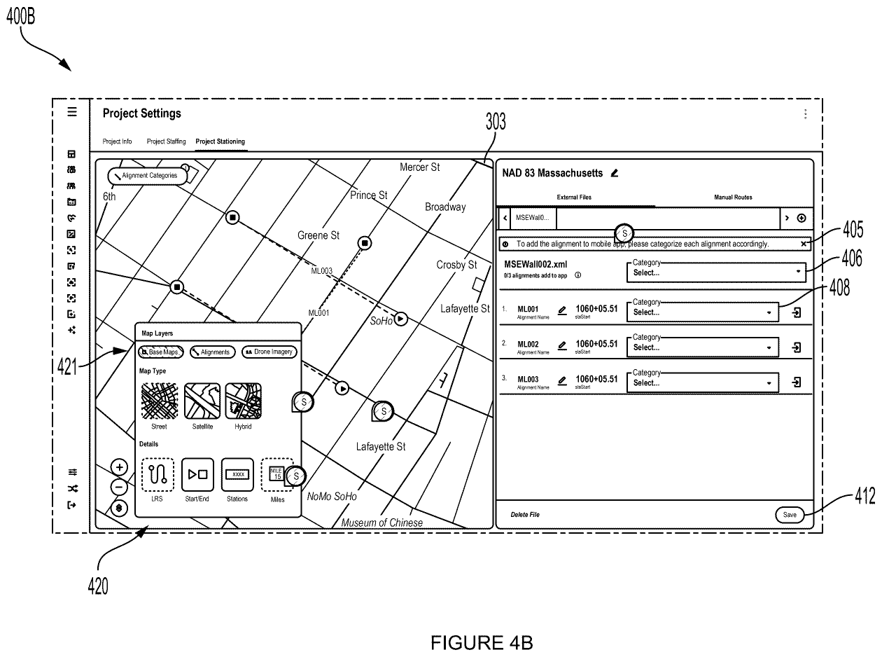

FIGS. 4A-B depict an example of stationing integration with view layers once routes and stations have been generated. As seen in FIG. 4A, a view 400A includes map module 303, as discussed above, showing a workflow immediately following, for example, that depicted in FIG. 3F. In particular, view 400A includes a route selection pane 422 including a tab menu 425 of available imported routes. Here, MSEWall002 is selected and includes routes ML001, ML002, and ML003. Moreover, a layer options menu 410 is opened inside map module 303. Layer options menu 410 makes various layers available for users within the map module. Here, map module 303 is displaying only a Linear Referencing System (LRS) view, as indicated by LRS toggle 411A. Other options in layer options menu 410 may include a satellite imagery toggle 411B, a toggle 411C to show or hide all imported routes and/or alignments available in external files, a manual routes toggle 411D, a toggle 411E to show or hide begin and end point icons, and a toggle 411F to show or hide begin and end point labels.

FIG. 4B depicts a view 400B which includes a categorized thumbnail view of a layer options menu 420. In the categorized thumbnail view, layer options menu 420 includes tabs 421 for “base maps,” “alignments,” and “drone imagery.” The base maps and alignments tabs correspond to the layer options shown in layer options menu 410 above. The drone imagery layer may be available to users who have associated drone-based image data with the respective project file. Moreover, in some examples, digital stations and routes, as described herein, can be used to automatically align and register drone image data to a corresponding map layer of LRS and/or satellite imagery data.

View 400B also includes a route categorization pane 405. Route categorization pane 405 enables a user to categorize a collection of routes via a category dropdown 406 or individual routes via category dropdowns 408. Categories may include, for example and without imputing undue limitation, “road,” “wall,” “lot,” and the like. Route and station categories can be used later to automate various activities such as electronic ticket handling, inspection records, work zone automations, and more. Once a user is satisfied with the categories, they may be saved by interacting with a save button 412.

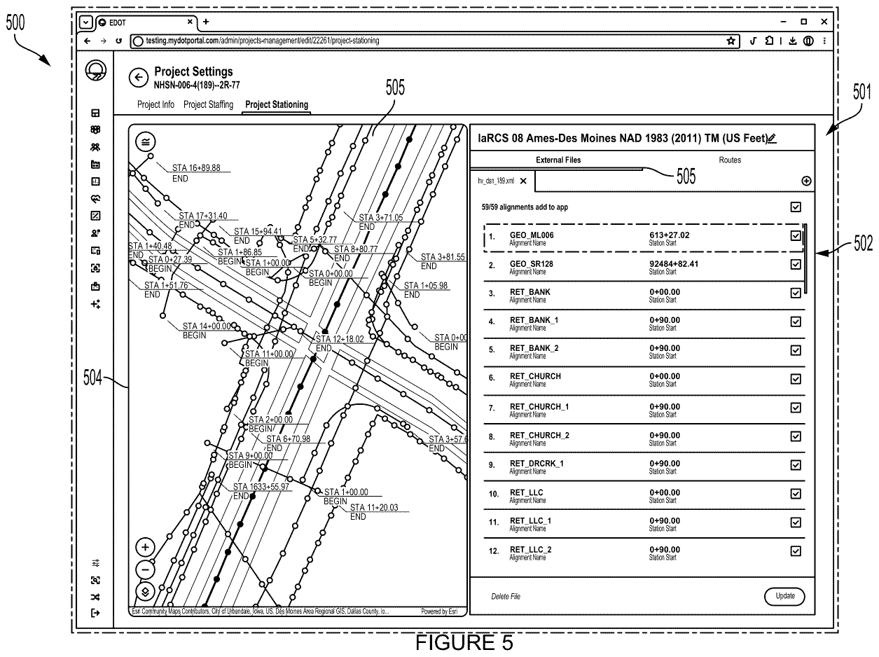

FIG. 5 depicts an example of a view 500 of a project settings window accessed through a web browser displaying a more complex project than the views discussed above. View 500 includes a modular map 504 on which multiple stationed routes 505 can be seen adjacent to a route creation pane 501. Each stationed route 505 corresponds to a route entry on a routes table 502 in an external files tab 505 of route creation pane 501.

FIG. 6 depicts an example of a view 600 of a project settings window accessed through a web browser displaying a more complex manually created route than the views discussed above. In view 600, a map module 615 is displayed adjacent to route creation pane 501, as in FIG. 5, however here it is set to a routes tab 601. Routes tab 601 includes a routes table 602, which includes a BEGIN point 611A and an END point 611B in respective rows. As can be seen visually in map module 615, when toggled to be displayed, a contrasting route line 612 is displayed on the rendered map.

Here, because BEGIN and END point icons toggle 620 within layer options menu 618 is toggled to an off position, icons indicating the start and end of route line 612 are not displayed. Stations 603 have been generated and rendered on the map along and on top of route line 612. Moreover, stationing has been automatically applied to the tabular view of the respective route, as can be seen in a “station #” column of routes table 602. BEGIN point 611A, being designated the starting point of the route, is connected to “1+00.00” in the station #column, indicating that the point is located exactly at station #1, having 00.00 feet of offset from the station. In comparison, END point 611B is connected to station 17 with an offset of 24.82 feet, as denoted by its station #value of “17+24.82.” While not shown here, it is noted that, in some examples, intervening stations 1-17 may be displayed as entries in routes table 602 as STATION points or the like.

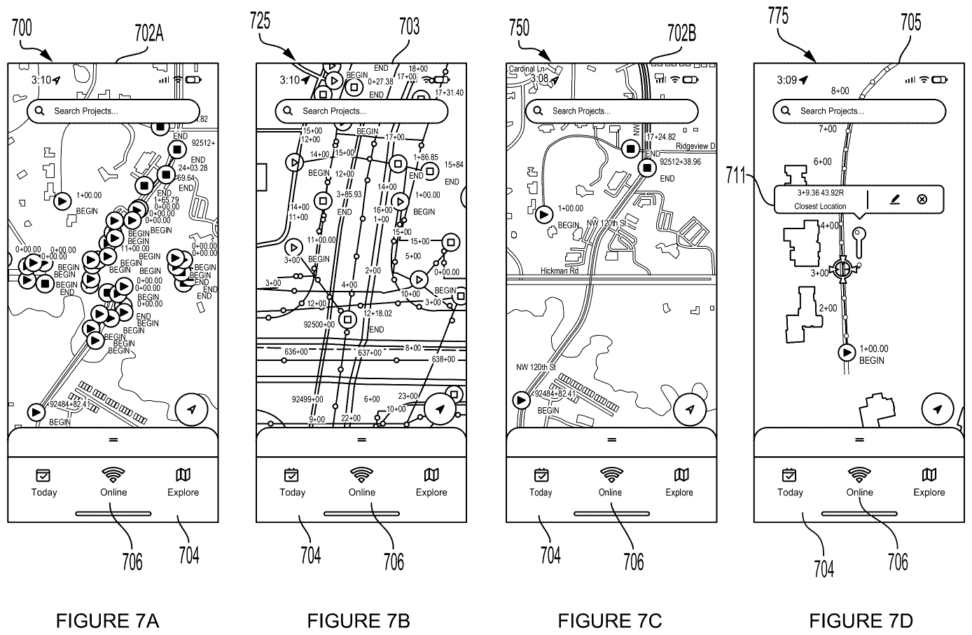

FIGS. 7A-D depict examples of interactive mobile application views 700, 725, 750, 775 of stationed routes created, for example, in a web application as discussed above. A user on a mobile application may access these by connecting a hosting server over a wireless network (e.g., wifi, cellular network, 5G, satellite uplink/downlink, etc.) or by applying a caching process storing relevant data on a corresponding mobile device when entering an area without sufficient network connectivity. Here, a connectivity icon 706 is highlighted to indicate sufficient network connectivity for connecting to project files. All of view 700, 725, 750, 775 are “map-centric.” That is, the views allocate primary default interface space to an interactive map module 702A-B, 703, 705, with an interactable menu (not shown) that may be swiped up or brought into prominence in the view through other gesture-based interactions with a view tab 704, disposed here towards the bottom of the screen.

View 700 is a display of all project routes in the displayed geographical area and includes BEGIN and END points of routes set to display along with station information for the displayed points, but with individual stations display set to off. Accordingly, map module 702A displays a LRS rendering of a project site map including smooth route lines each capped on both ends by respective BEGIN and END icons showing positioning to nearest stations in a “station+offset in feet” format for BEGIN and END points. In comparison, view 725 is a display with BEGIN and END points of routes toggled on as well as individual stations being toggled on. Accordingly, map module 703 displays route lines with interspersed sequential easily identifiable shapes contrasting the line, here circles, included in the layer renders.

View 750 includes a map module 702B, which depicts the same project site map in LRS rendering as map module 702A in view 700 discussed above. In view 750, only a subset of two routes are set to be displayed, reducing visual clutter and allowing the user to focus on the selected particular routes. View 775 includes a map module 705 of a different project site. A single route is displayed with stationing as well as BEGIN and END points. Moreover, view 775 includes a station suggestion modal 711, which may utilize a device's geolocation services (e.g., GPS, etc.) and geolocation data embedded in the map displayed by map module 705, data objects storing stations, and/or project data or data associated with the project like digital tickets. Station suggestion modal 711 identifies a nearest relevant station and displays the station as well as a predicted offset. Here, for example, station suggestion modal 711 has identified station “3” as the nearest relevant station and “9.36” feet as the offset.

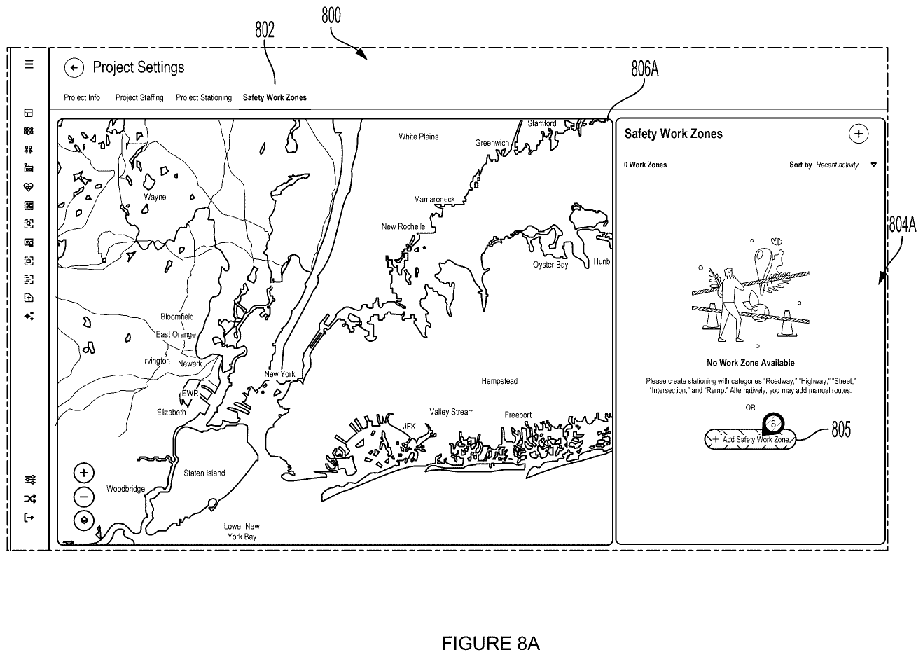

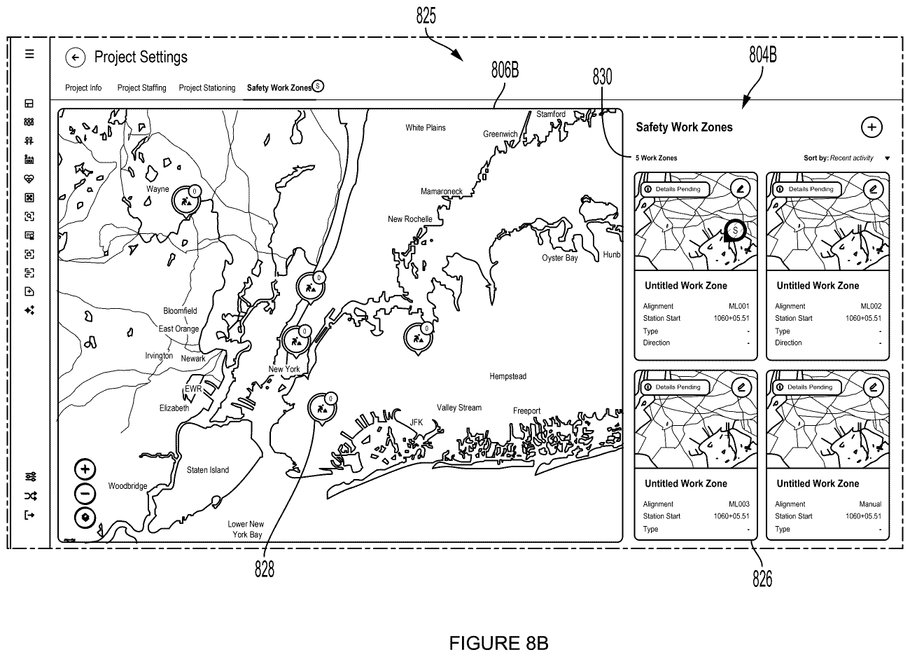

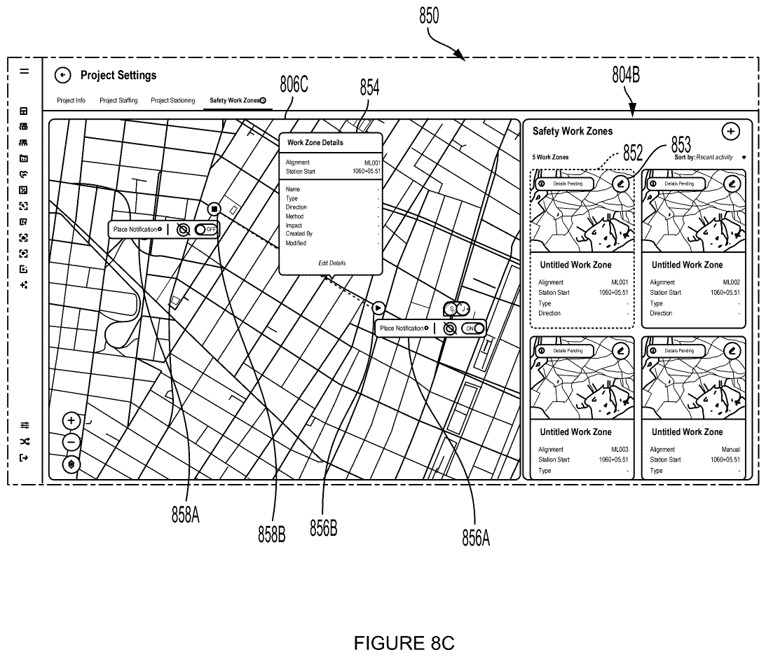

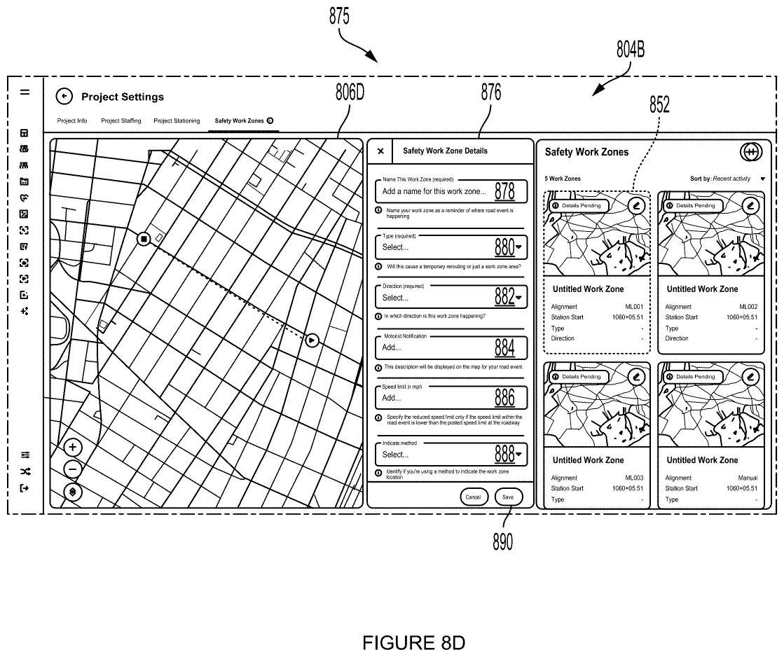

FIGS. 8A-D depict an example of a UX flow for creating safety work zone automations for a construction project using generated stations and routes. In one example, work zones may be created and managed through a web application accessed via internet browser by an authorized project administrator or owner. Once set up, a safety work zone for a project can be accessed through the project's settings page and modified, deleted, archived, and/or manually set into an “active” state. Active safety work zones transmit their active status to relevant data consumers, such as navigation services, government portals, monitoring services, and the like. In some examples, safety work zones may be activated and/or deactivated by applying various rules and/or trained models to data signals from the relevant worksite, such as equipment activation or use, vehicle status, monitoring system alert, and other transmitted indicators originating from the worksite.

As depicted in FIG. 8A, a safety work zones tab 802 of a project settings view 800 includes an interactive map module 806A adjacent to a safety work zones management pane 804A. Safety work zones management pane 804A queries a corresponding project database for any available safety work zones with which to populate the pane. As depicted here, no safety work zones are available. Whether or not existing safety work zones are available to safety work zones management 804A, users are presented with an add safety work zone button 805. Interacting with add safety work zone button 805 brings the user to a safety work zones management pane showing routes associated with the project (not shown). In this route selection pane, the user can identify which routes are to be part of the new safety work zone. Once the intended routes are selected, the user may confirm the safety work zone and a safety work zone file will be created and associated with the project.

FIG. 8B depicts a view 825 of a project for which multiple safety work zones are set up and available. As shown, view 825 includes an interactive map module 806B is adjacent to safety work zones management pane 804B. Here, safety work zone management pane 804B has received five existing work zones in response to its query, as indicated by a work zone tally 830 at a top portion of safety work zones management pane 804B. Each existing available safety work zone is displayed in safety work zone management pane 804B as a safety work zone tile 826. Safety work zone tile 826 includes summary information on its face and may be interacted with to make modifications. In addition, safety work zone tiles 826 are linked to corresponding safety work zone icons 828, which are distributed across a map rendered by map module 806B responsive to the geographic distribution of all safety work zone tiles 826 in safety zones management pane 804B and according to their approximate geographic location.

FIG. 8C is of a detail display as shown by a project settings web application view 850. View 850 includes a map module 806C which includes a work zone details modal 854 displaying additional details of a selected safety work zone tile 852 in safety work zones management pane 804B. Work zone details modal 854 includes the alignment or route name it is associated with, the station and offset value, here “1060+05.51,” of the safety work zone starting point, safety work zone name, type, direction, method, impact, creator name, and modification date. Additionally, as shown here, an activated notification toggle 856A is displayed proximate to a route BEGIN point 856B and a deactivated notification toggle 858A is displayed proximate to a route END point 856B. Safety work zone tile 852 includes an edit icon 853 which, when interacted with, transfers the user to a UX for editing the information included in work zone details modal 854.

FIG. 8D depicts a view 875 which is an example of the UX for editing the information included in work zone details modal 854. View 875 includes a map module 806D which is truncated to make room for a safety work zone details editing pane 876, disposed between map module 806D and safety work zones management pane 804B. As discussed above, view 875 may be entered into by interacting with an edit icon on safety work zone tile 852 in safety work zones management pane 804B. In safety work zone details editing pane 876, the corresponding work zone may be named by inputting into a free text name field 878. The type of work zone may be set via a work zone type dropdown 880, which includes options such as, for example, paving, painting, removal, excavation, etc. A direction dropdown 882 enables a user to set a directionality to the work zone. Motorist notification free text field 884 may be used to set a notification text, if any, for motorists approaching the work zone in a direction determined by direction dropdown 882. Speed limit free text field 886 will output any entered changed speed limit to downstream consumers, such as direct to vehicles or to mapping and navigation services. Indication method dropdown 888 allows users to select a predetermined method, algorithm, model, etc., for determining work zone activity automatically. When a user is satisfied with the field values, they may interact with a save button 890 to lock the settings into the project settings file.

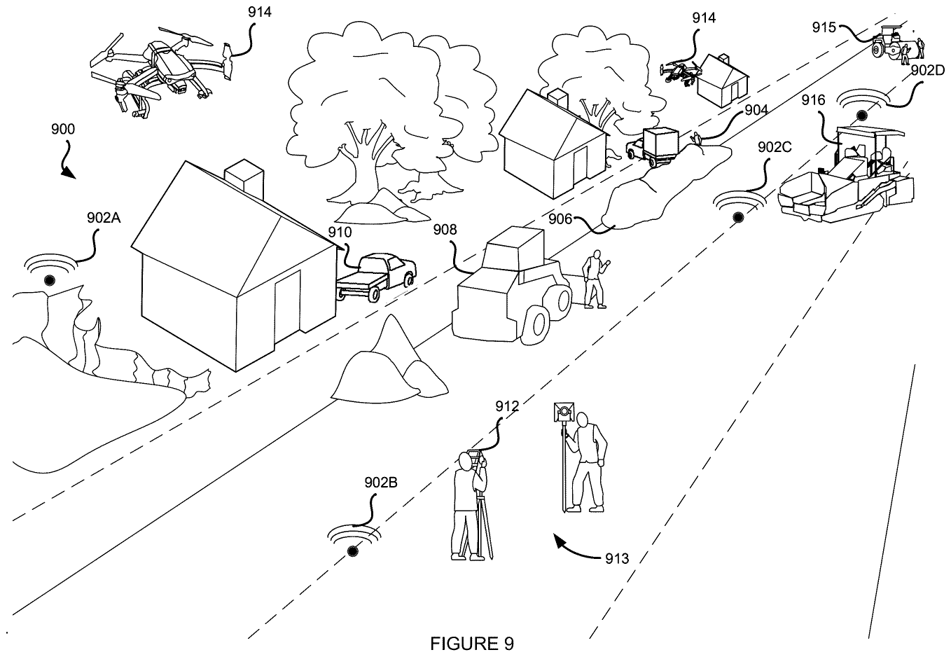

FIG. 9 depicts an example of a digitally stationed project site 900 in which some of the benefits and advantages of the methods and systems of this disclosure may be realized. Digital stations 902A-D may be generated automatically as discussed above or may be manually placed. In either case, digital stations 902A-D are virtual and need not have any direct visual indicia in physical space. An application can determine the positions of the station, both relative to the device executing the application and/or relative to other recorded elements of the construction site, through accessing a geolocation component of the device (e.g., a GPS, accelerometer, etc.) for positioning data and comparing against a relevant project site database either remotely or locally if networks are inaccessible and corresponding relevant data has been cached in local memory. In some examples, relative positioning with regard to digital stations 902A-D may be done or further enhanced by computer vision algorithms, such as simultaneous localization and mapping (SLAM) and the like, in combination with correlated geographical coordinate data and visual anchors or markers.

Digital stations 902A-D include in corresponding data designations of the type of work site to which they are attached. For example, digital station 902A is disposed away from a road and by an eroding wall, and so in this example has been set as a retention wall work site. In comparison, digital stations 902B-D are disposed along a stretch of road and so are set as road work sites in this example.

In some examples, digital stations 902B-D may have more granular work site types to which they may be categorized, such as surveying work for 902B, milling for 902C, and paving for 902D. In some examples, the work site type may be determined automatically based on active equipment signals in proximity to a digital station (e.g., digital station 902B is proximate to a surveying system 912, digital station 902C is proximate to a miller 916, and digital station 902D is proximate to a paver 915).

In some examples, autonomous site monitoring systems may also, or alternatively, be used to automatically activate safety work zones. Here, for example, unmanned aerial vehicles (UAVs) 914 are deployed to monitor digitally stationed project site 900. When UAV 914 detects that work is taking place or will soon take place at digitally stationed project site 900, it may transmit a signal to, e.g., infrastructure layer 202 discussed above indicating work zone activity. The signal may include the type of activity, geolocation, and/or nearest relevant stations or safety work zones. UAV 914 may determine these values using onboard methods, remote methods, or a mix of both, such as computer vision, near field communications (NFC), integrated GPS, and more. In response to receiving the signal, infrastructure layer 202 may apply various rules to determine whether to activate the safety work zone and forward that information on to consuming services.

Digitally stationed project site 900 is an active work site and so, in some examples, a safety work zone may be activated automatically or manually through a web portal as discussed above. In the case of both manual and automated safety work zones, stations 902A-D may be part of a shared route configured to include a safety work zone. A set of safety work zone activation rules, further discussed below, may be linked to the safety work zone which will enable the safety work zone to switch between active and inactive states. Alternatively, or additionally, digital station 902A may be in a different defined safety work zone than digital stations 902B-D and so digital station 902A may effectively be linked to two different sets of safety work zone activation rules via its inclusion in different safety work zones.

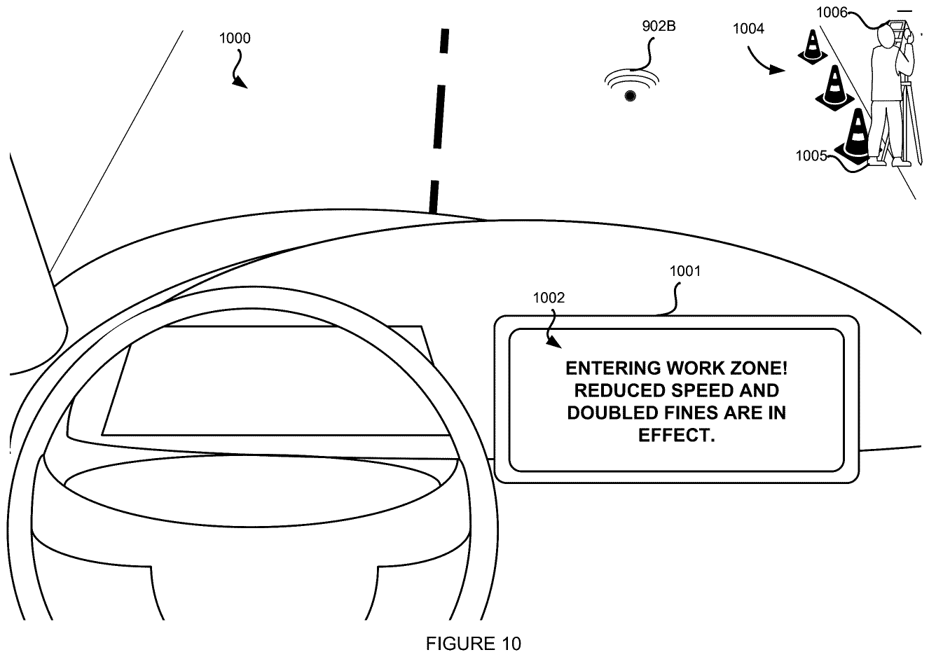

Here, a survey team 913 is surveying in relative proximity to digital station 902B. Survey team 913 uses a network connected surveyor device 912 which transmits activity state and geolocation data to a manufacturer-provided service and/or directly to infrastructure layer 202. Using the activity state and geolocation data, various processes on infrastructure layer 202 applying linked rules may infer that any safety work zone(s) associated with digital station 902B should be in an active state. Accordingly, infrastructure layer 202 transmits properly formatted updates to, e.g., external navigation services to trigger alerts to connected drivers approaching the corresponding safety work zone, as shown in FIG. 10.

Another feature depicted in FIG. 9 is automatic station-based logging and project progress updating. For example, the activity of survey team 913 discussed above may be automatically logged into a database and linked to digital station 902B. In some examples, that activity may be compared against a project specification database by a conciliation service and project requirements may be logged as having been completed or progressed accordingly, as further discussed below.

Likewise, equipment such as a paver 915, a miller 916, or a front loader 908 may be configured to automatically update a project progress with a conciliation process hosted on a supporting infrastructure. In one example, paver 915, miller 916, and front loader 908 each provide status and location updates to respective original equipment manufacturer (OEM) web services. A conciliation process run on the supporting infrastructure regularly queries the OEM web services for respective equipment updates regarding paver 915, miller 916, and front loader 908.

When a status change is detected in the updates, an inference process may be executed on the supporting infrastructure as to the respective activities being performed by paver 915, miller 916, and/or front loader 908 using the status and location updates data as well as contextual data associated with digital stations 902C-D. The conciliation process may then use the respective inferred activities and a corresponding project database to either or both log the activities and associate them with appropriate project records and/or determine project status updates, such as completion status of contractor obligations. In some examples, if a contractor compensation is tied to, for example, milestone payouts or the like, completion status updates may trigger downstream disbursements or the like, automatically, manually, or through a combined process.

There are various approaches to detecting work site activity when the activity does not utilize connected construction equipment. For example, as discussed above, UAVs 914 may be equipped with various sensors and utilize computer vision techniques to identify workers on the site and their activities. In another example, transport vehicle sensors may be utilized to infer work site activity. Here, a truck 910 is equipped with a status transmitter, which may be configured to notify infrastructure layer 202 of status changes, such as engine on/off, changes in geolocation, speeds, systems information, etc. Specialized rules associated with transport vehicle equipment may be used to infer work site activity. For example, when truck 910 parks within closest proximity to a station including manual work activities associated with its location, the vehicle being in an off-state and/or not moving for a certain period of time indicate a higher likelihood of work activity taking place and thus a corresponding safety work zone may be automatically switched into an active state and/or a project administrator may be alerted for informational or manual activation purposes.

In addition, delivery of materials and inspection and logging of said materials may be made more efficient, consistent, and rapid by the systems and methods of this disclosure. As depicted in FIG. 9, an inspector 904 is at a material drop off 906. Material drop off 906 may be, for example and without imputing undue limitation, a delivery of asphalt or the like. Inspector 904 is responsible for verifying the quality, quantity, time, and location of the delivered material; however, in the art, it is typical for the inspector to manually enter a station and offset value, either in a paper ticket or through a mobile application. Here, using the inspector's mobile device's geolocation data, project specification data, and digital stations data, digital station 902C may automatically be determined to be the appropriate station to associate with the inspection. In some examples, a list of one or more stations may be provided to inspector 904 to select from as they fill out their report on a mobile device. In other examples, the list may additionally be ranked according to a respective digital station's likelihood of being appropriate for the report.

FIG. 10 depicts an example of a driver's view 1000 as they approach, e.g., digitally stationed project site 900. A surveyor 1005 is performing a survey 1004 using a connected surveying device 1006. An active safety work zone alert 1002 is displayed to the driver via navigation console 1001 as the vehicle approaches the location of digital station 902B.

The depicted benefit may be enabled by the methods and systems disclosed herein. For example, infrastructure layer 202 may receive an equipment status update from connected surveying device 1006. The equipment status update may then be associated with digital station 902B and thereby also be determined to impact a safety work zone. Once the safety work zone is identified, corresponding safety work zone activity rules may be determined and applied to the equipment status update and other contextual data. Accordingly, the result of the rules may be to switch the identified safety work zone into an active status and send out appropriate update notifications to navigation services supporting navigation console 1001 to cause active safety work zone alert 1002 to be displayed when relevant vehicles are approaching the beginning of the safety work zone. Notably, the entire process may be done rapidly and with minimal or even no human intervention.

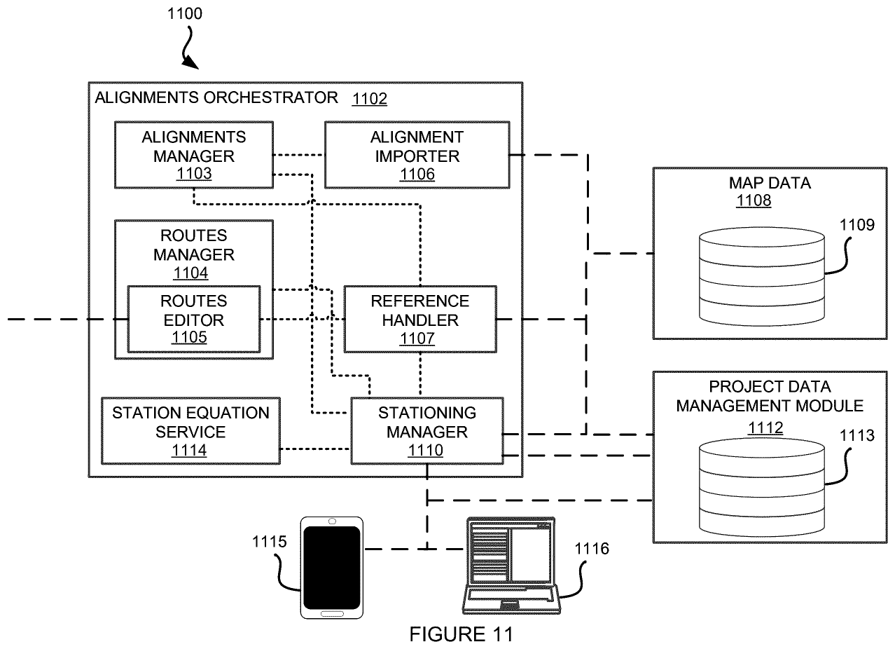

FIG. 11 depicts an example of an alignments and stationing system 1100 that may generate and digitally station alignments and routes for construction sites. Alignments and stationing system 1100 includes an alignments orchestrator 1102 in communications with a map data repository 1108. Map data repository 1108 includes a database 1109 storing geographic data in a variety of formats, such as LRS and the like. While a single database is depicted here, it is to be understood that a variety of data storage structures fall within the scope and spirit of the disclosure.

Alignments orchestrator 1102 includes an alignments manager 1103 which enables a user to import alignments from existing files, such as CAD files, and generate appropriate digital stationing. Alignments manager 1103 provides the import file to alignment importer 1106, which may then extract relevant location data and store it in map data repository 1108 in association with a relevant construction project. Alignments manager 1103 may also provide extracted alignments to stationing manager 1110 to generate digital stations along the extracted alignments.

In the case of a manual route creation process, routes manager 1104 includes a routes editor 1105 which receives user input with which routes manager 1104 generates alignment data structures as described above. Alignments generated by routes manager 1104 are provided to stationing manager 1110, which generates digital stationing for the created alignments and saves said digital stationing to map data repository 1108.

When stationing manager 1110 receives a receives an alignment, from either alignments manager 1103 or routes manager 1104, it first distributes digital stations according to the start, end, and/or equation station of the alignment. If there is a stationing equation to be generated or provided, stationing manager 1110 determines the station equation and then determines the location of the equation station based on the station equation and the alignment. When the initial stations have been distributed to the alignment, stationing manager 1110 then distributes the remaining intermediary stations sequentially along the alignment, from the start station to the end station, unless there is an equation station, in which case stationing manager 1110 distributes intermediary stations from the start station to the equation station and then from the equation station to the end station.

Moreover, as depicted in FIG. 11, a mobile device 1115 or a computer 1116 may retrieve station and alignment data, by installed software or through a web application. In some examples, alignment and station data may be retrieved directly from a project database 1113 via a project data management module 1112. In such a case, visual offsets, such as tick marks, are rendered on mobile device 1115 or computer 1116 between subsequent stations at equivalent to 50 foot intervals. In some examples, mobile device 1115 and/or computer 1116 may retrieve station data from stationing manager 1110, which will determine the visual offsets and provide it back to the querying device for rendering.

Further, alignments manager 1103, routes manager 1104, and stationing manager 1110 interface with reference handler 1107 so that alignments, routes, and digital stations may be associated with a human readable reference and retrieved from and stored in project database 1113 by project data management module 1112.

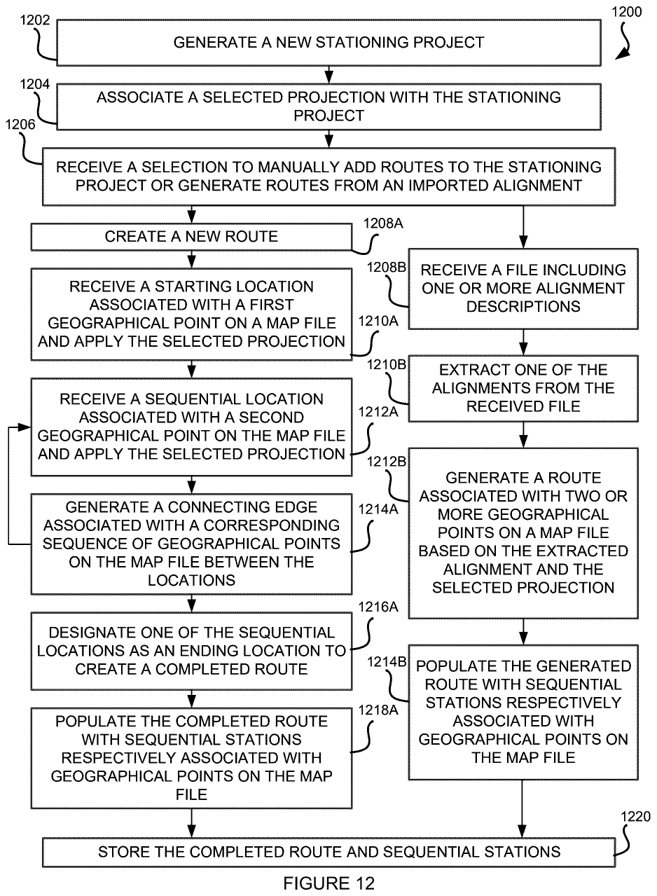

FIG. 12 depicts an example of a method 1200 for generating digitally stationed routes and alignments. Method 1200 may be performed on a variety of systems, including, for example, alignments and stationing system 1100 discussed above. Method 1200 includes a bifurcated flow, sequence A, that is steps 1208A-1218A, covers a manual route process, whereas sequence B covers an automated process.

In any case, at step 1202, a new stationing project is generated. This may, for example, include setting aside or pre-allocating sufficient memory for the project. Additionally, this may include identifying appropriate projections from an associated project database and providing those projects as selectable options to the user.

At step 1204, a projection selected by the user is associated with the stationing project.

At step 1206, either a selection to manually add routes is received or a selection to generate routes and other alignments from external alignment files is selected. As discussed above, in the case of the former, at step 1208A, a new route is created within the stationing project.

At step 1210A, a starting location is received that is associated with a first geographical point on a map file and the selected projection is applied.

At step 1212A, a sequential location associated with a second geographical point on the map file is received and the selected projection is applied to it.

At step 1214A, a connecting edge is generated that is associated with a corresponding sequence of geographical points on the map file, such as coordinate points, between the starting location and the sequential location. In some examples, steps 1212A-1214A may repeat, such as for exceptionally long or circuitous routes.

At step 1216A, a sequential location is designated as an ending location, thus creating a completed route.

At step 1218A, the completed route is populated with sequential stations respectively associated with geographical points on the map file. The stations are generated at regular intervals according to a predetermined distance, such as 50 feet or 100 feet, for example.

At step 1220, the completed route and sequential locations are stored for later retrieval and use.

Alternatively, if the user selects to generate routes from an imported alignment at step 1206, at subsequent step 1208B, a file is received which includes one or more alignment descriptions. The file may be in various formats, such as a CAD file, XML, YAML, BIM, DWG, and the like. The alignment descriptions are formatted into a form that is computer-readable according to the file format.

At step 1210B, an alignment is extracted from the received file.

At step 1212B, a route is generated with two or more geographical points on a map file based on the extracted alignment and the selected projection. The map file may be an internally stored format or a map product maintained by a third party. In any case, the generated route is converted from the imported alignment syntax and to a syntax that may be applied to the map file.

At step 1214B, the generated route is populated with sequential stations respectively associated with geographical points on the map file. Both steps 1218A and 1214B may be performed by the same stationing process as, in some examples, the imported and manually created routes are of the same type of data format.

As with the method flow A, here method 1200 continues after step 1214B to step 1220, where the completed route and sequential stations.

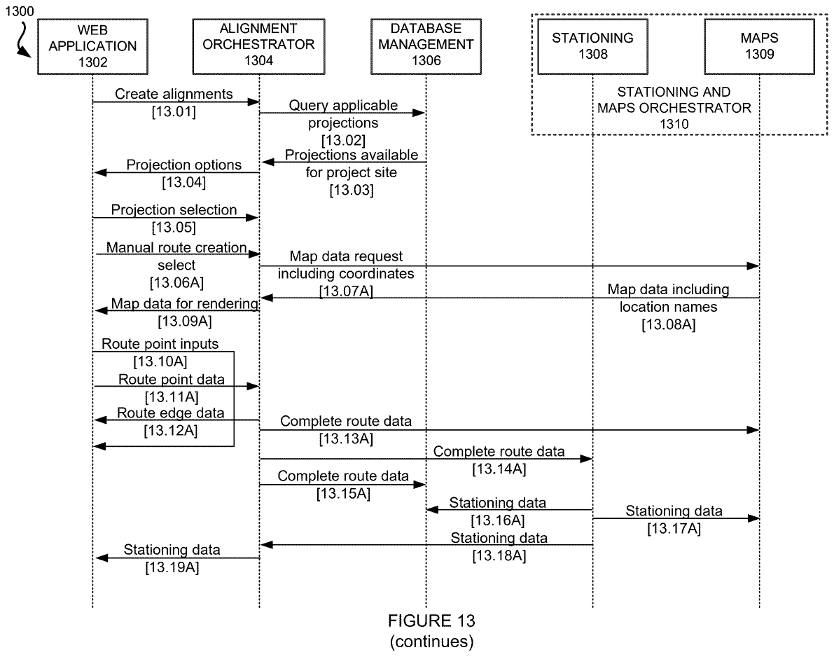

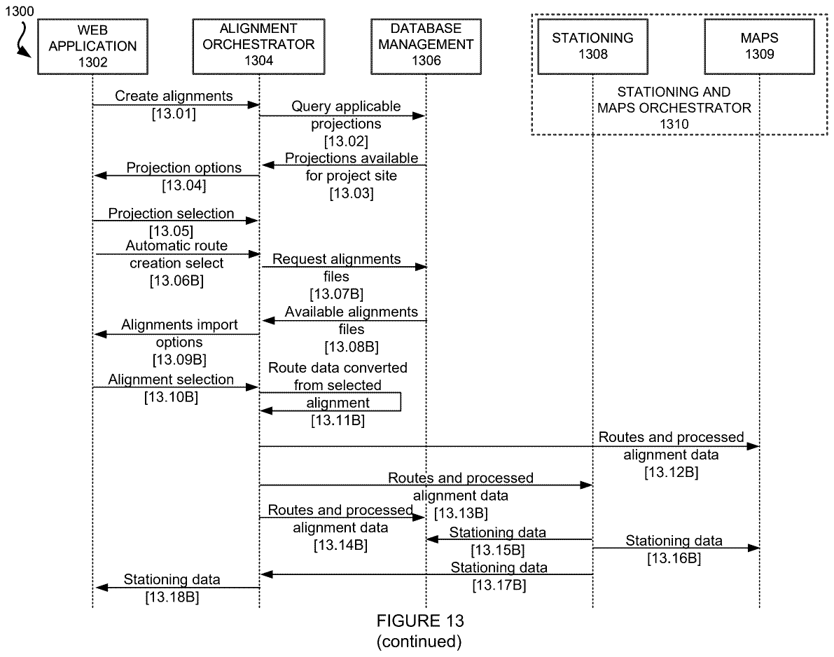

FIG. 13 is a sequence diagram depicting an example of a process sequence 1300 for generating digitally stationed routes and alignments. A web application 1302 is triggered by a user input to pass a create alignments message 13.01 to alignment orchestrator 1304.

Alignment orchestrator transmits a query 13.02 for applicable projections to a database management 1306. Database management 1306 returns a query response 13.03 including projections that are available for the respective project site.

Alignment orchestrator 1304 then transmits the available projection options data 13.04 to web application 1302. Web application 1302 sends the projection selected by the user 13.05 to alignment orchestrator 1304. In some examples, web application 1302 also separately sends user selection to manually create a route 13.06A. This selection may include input coordinates for the start of the route.

Alignment orchestrator 1304 then transmits a map data request including any input starting point coordinates 13.07A to maps 1309, which may be an internal or third party mapping service, or some combination of the two.

Maps 1309 response with map data suitable for rendering a map to the user and location names 13.08A, like streets and the like. Receiving alignment orchestrator 1304 provides map data suitable for rendering a visual map 13.09A to web application 1302.

At this point, a user generates route point inputs 13.10A on web application 1302. During this sequence, web application 1302 sends route point data 13.11A to alignment orchestrator which transmits back route edge data 13.12A for rendering route lines between the points to the user.

When the user indicates the route is complete, alignment orchestrator sends the complete route data 13.13A to maps 1309 for storage. Alignment orchestrator also sends complete route data 13.14A to station 1308 for generating digital stationing, as well as complete route data 13.15A to database management 1306 to be saved to a corresponding project file.

Stationing 1308 generates digital stationing based on the complete route data and sends the stationing data 13.16A to database management 1306. Stationing 1308 also sends stationing data 13.17A to maps 1309, and stationing data 13.18A back to alignment orchestrator 1304. Alignment orchestrator 1304 then transmits stationing data 13.19A to web application 1302 in a form and syntax able to be rendered by web application 1302 on, for example, a map.

FIG. 13 continues to show an alternative section of process sequence 1300. While data sequences 13.01-13.05 remain the same as above, here an automatic route creation command 13.06B is selected by the user and transmitted from web application 1302 to alignment orchestrator 1304.

Alignment orchestrator 1304 then sends a request for available alignments files 13.07B to database management 1306. Database management 1306 returns one or more available alignments files 13.08B to alignment orchestrator 1304. Alignment orchestrator 1304 sends alignment import options 13.09B to web application 1302 from which the user may choose which to import.

Web application 1302 sends alignment selection 13.10B to alignment orchestrator 1304. Alignment orchestrator 1304 then proceeds to generate route and projection-adjusted alignment data from the selected alignment 13.11B.

Alignment orchestrator 1304 sends the routes and processed alignment data 13.12B to maps 1309 for integrated storage there. Alignment orchestrator 1304 also sends the routes and processes alignment data 13.13B to stationing 1308 for generating digital stations. Alignment orchestrator 1304 further sends routes and processed alignment data 13.14B to database management 1306 for storage and later retrieval.

Stationing 1308 transmits stationing data 13.15B generated from the routes and alignments. Stationing 1308 also sends stationing data 13.16B to maps 1309 and stationing data 13.178B to alignment orchestrator 1304, which passes the stationing data 13.18B to web application 1302 for visually rendering for users.

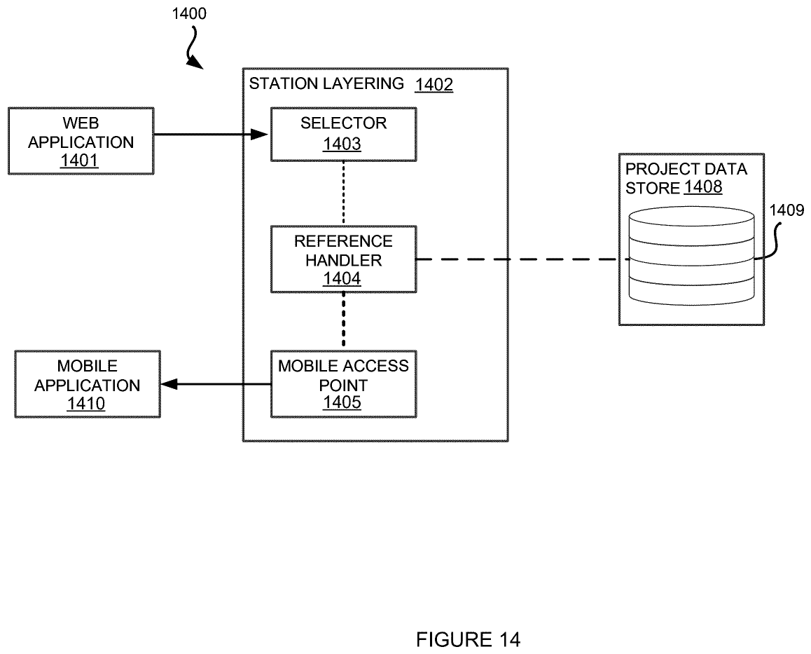

FIG. 14 depicts and example of a system 1400 for selecting which stations and routes are viewable on mobile devices. System 1400 may be used by a user at a web application 1401, such as an administrator or project manager, to set which routes and stations are available for view by users at a mobile application 1410, such as inspectors and the like.

Web application 1401 interfaces with a station layering process 1402 through a selector 1403. Selector 1403 retrieves stored common names for routes and stations by communicating with a reference handler 1404, which functions as an interface between station layering 1402, and its components, and a project data store 1408. Here, project data store 1408 is depicted as including a database 1409, but it is understood that various other configurations for long term project data storage may be used.

Selector 1403 retrieves all available stations and alignments, including routes, data from project store 1408. In response to user inputs, selector 1403 may flag any available stations or alignment layer to be available to mobile application 1410. These flag may be stored in project data store 1408 for each alignment and or stations sequence respectively. When mobile application 1410 connects to mobile access point 1405, only those stations sequences and alignments flagged as viewable will be provided from project data store 1408 through reference handler 1404 and to mobile application 1410.

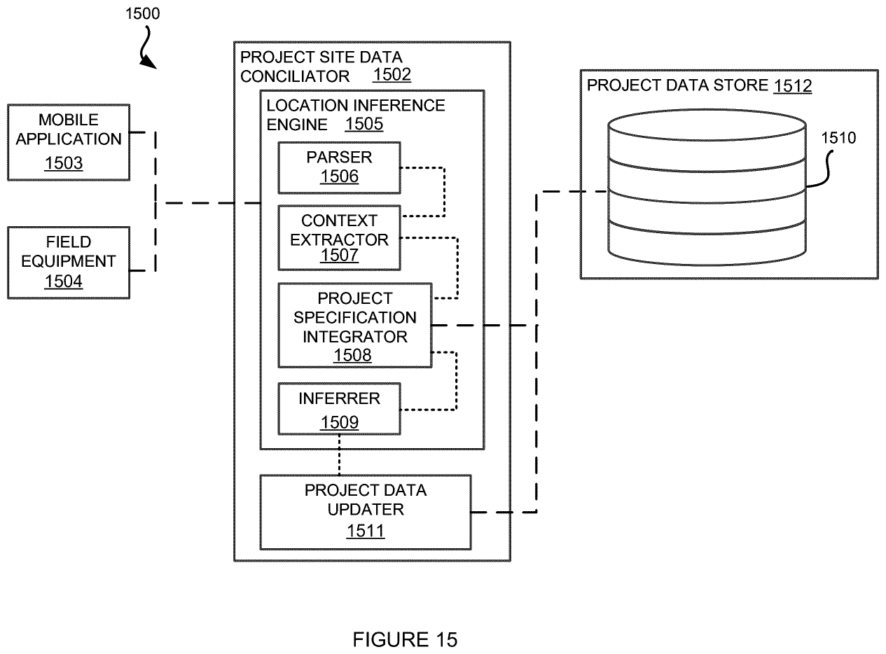

FIG. 15 depicts an example of a system 1500 for conciliating data directly from a project site with a corresponding project data store, such as for updating project progress or automatically checking for fulfilment of obligations under a project specification and/or contract.

System 1500 includes a project site data conciliator 1502 communicatively connected to a mobile application 1503, field equipment 1504, and a project data store 1512. In some examples, field equipment 1504 may be connected to project site data conciliator 1502 indirectly, such as through a manufacturer web service or the like (not depicted). Project data store 1512 here includes a database 1510, but it is to be understood that various data storage architectures may be used. Project data stores 1512 may include project management data, contracts data, project specification data, and/or as-built databases, such as those described in “Automatic Digital As-Built Database Populator and Construction Material Delivery Location Estimator”, Ser. No. 19/072,108, incorporated herein by reference in its entirety.

Project site data conciliator 1502 includes a location inference engine 1505 and a project data updater 1511. Location inference engine 1505 processes data from mobile application 1503 and/or field equipment 1504 and compares it against project specification data from project data store 1512 to determine the nearest relevant digital station with which to associate a project site event. Project data updater 1511 determines which portions of project data need to be updated based on the outputs of location inference engine 1505, and then does so by performing write operations on project data store 1512.

Location inference engine 1505 includes a parser 1506, context extractor 1507, project specification integrator 1508, and inferrer 1509. When data is received from field equipment 1504 or mobile application 1503, parser 1506 conforms the data, such that is necessary, to a format that may be further processed by the other components of location inference engine 1505. Context extractor 1507 determines the relevant contextual data useful for inferring a digital station with which to associate the data from the parsed data output from parser 1506.

Once the data has been parsed and context extracted, project specification integrator retrieves relevant project specification data using values in the parsed and context data. Inferrer 1509 may then ingest parsed data, context data, and project specification data to determine which digital station is both closest and relevant to the update. For example, a delivery of a retention wall component may be inspected and delivered to a roadside station, however a station set beside a retention wall in need of repair may be the correct station to associate with the delivery. System 1500 extracts contextual data, such as contractor involved, vendor involvement, and project data identifying a station as a retention wall and the delivery obligation of the contractor for a retention wall component. As a result, system 1500 associates the more distant retention wall station to the delivery, and updates project data store 1512 to reflect the successful delivery to the retention wall station.

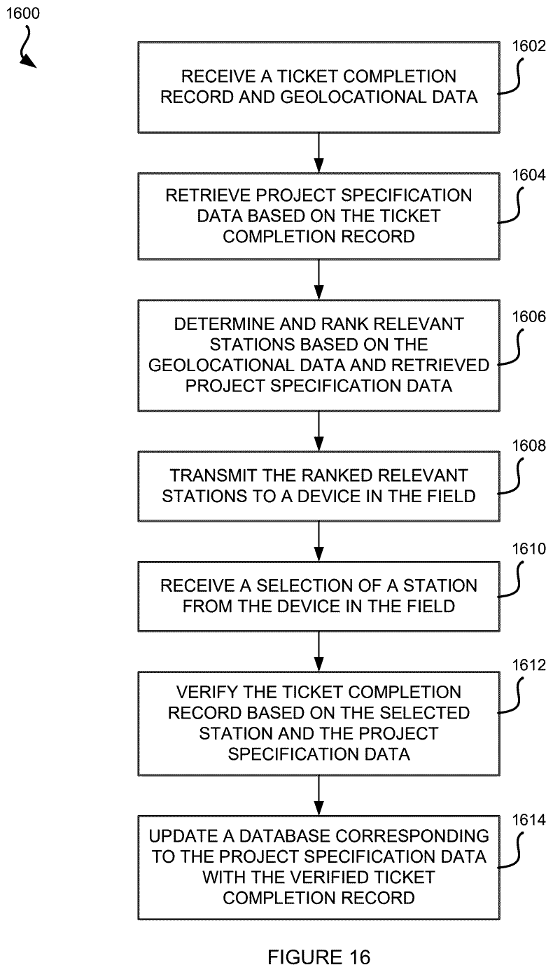

FIG. 16 depicts an example of a conciliation method 1600 for processing electronic ticket data automatically using digital stations. Conciliation method 1600 may be performed by system 1500, for example.

At step 1602, a ticket completion record and corresponding geolocation data is received.

At step 1604, project specification data is retrieved based on the ticket completion record.

At step 1606, a list of relevant stations are determined and ranked based on the geolocational data and retrieved project specification data.

At step 1608, the ranked relevant stations are transmitted to a device in the field.

At step 1610, a selection of a station from the list of ranked relevant stations is received from the device in the field.

At step 1612, the ticket completion record is verified based on the selected station and project specification data.

At step 1614, a database corresponding to the project specification data is updated with the verified ticket completion record.

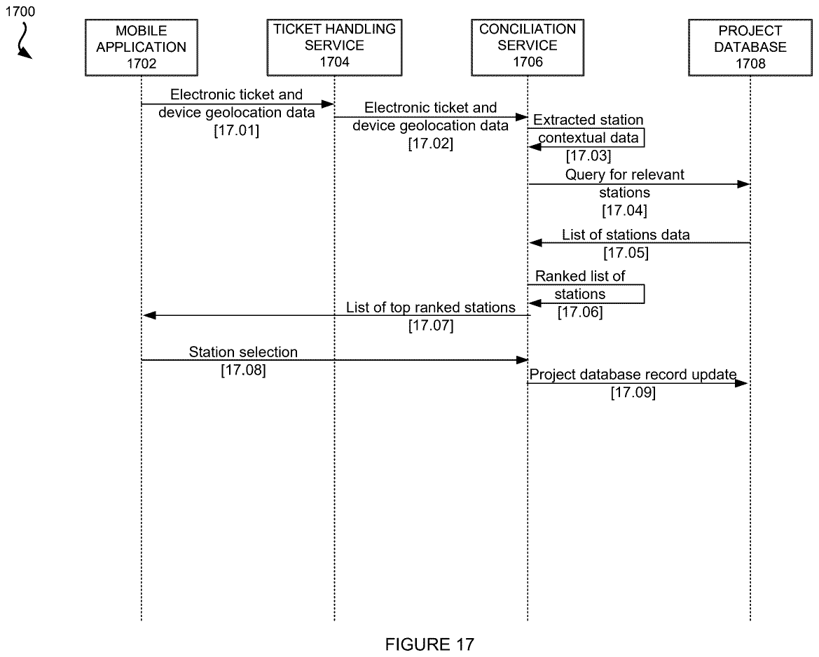

FIG. 17 is a sequence diagram depicting an example of a process sequence 1700 for conciliation of electronic ticket data with project records based on stations data. A mobile application 1702 first sends an electronic ticket and device geolocational data 17.01 to a ticket handling service 1704.

Ticket handling service 1704 then sends the electronic ticket and device geolocation data 17.02 to a conciliation service 1706. At conciliation service 1706, contextual data related to station selection 17.03 is extracted and further processed by conciliation service 1706.

Conciliation service 1706 then sends a query for relevant stations 17.04 to project database 1708. The query is generated based on the extracted station contextual data. Project database 1708 responds with a list of stations data 17.05 matching the query. Conciliation service 1706 then generates a rank list of stations 17.06, to which it applies predetermined thresholding to send a list of top ranked stations 17.07 to mobile application 1702.

Mobile application 1702 sends a station selection 17.08 to conciliation service 1706 generated by a user on-site. Conciliation service 1706 then updates project database records 17.09 at project database 1708.

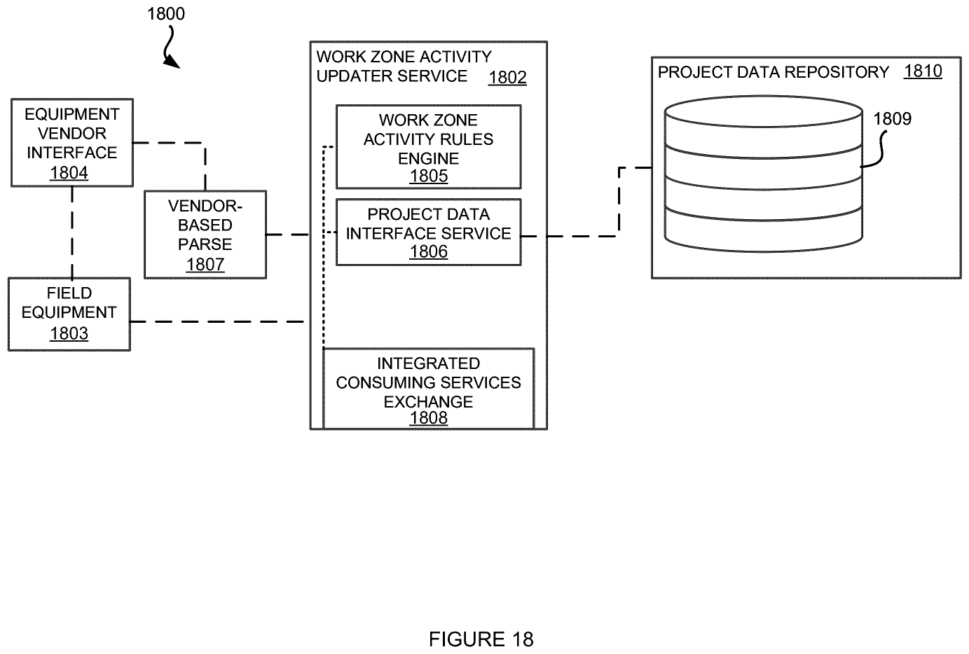

FIG. 18 depicts an example of a system 1800 for managing safety work zones. A work zone activity updater service 1802 sits between a project data repository 1810 and field equipment 1803, automatically updating activity statuses of predefined safety work zones based on detected equipment activity. Moreover, in some examples, work zone activity updater service 1802 may connect to electronic ticketing systems as well to detect when a safety work zone should be flagged as active (not depicted). While project data repository 1810 is depicted here as a database 1809, it is to be understood that other architectures and configurations may be utilized to equal effect.

In some examples, field equipment 1803 may instead, or additionally, update an equipment vendor interface 1804 with status updates. In such cases, a vendor-based parse 1807 preprocesses equipment data before forwarding the preprocessed data to work zone activity updater service 1802. Vendor-based parse 1807 may cover a variety of rules- and/or machine learning-based parsing approaches which may be modified uniquely to each equipment vendor interface 1804.

Work zone activity updater service 1802 includes a work zone activity rules engine 1805, a project data interface service 1806, and an integrated consuming services exchange 1808. When work zone activity updater service 1802 receives a status update from field equipment 1803, equipment owner information is extracted from the equipment update and project data interface service 1806 uses it to retrieve appropriate work zone activity rules from project data repository 1810. The retrieved work zone activity rules are then executed by work zone activity rules engine 1805 to determine whether to change an active status associated with corresponding safety work zones. When an activity status change is determined, project data interface service 1806 sends an accordant update to project data repository 1810 and integrated consuming services exchange 1808 formats and sends a notification to subscribing services, such as navigation services and the like.

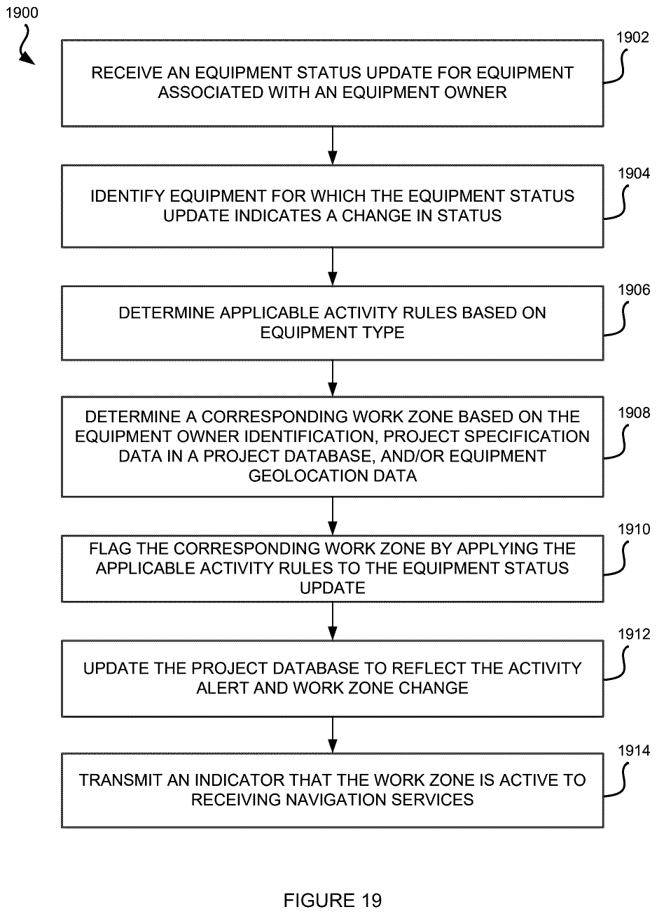

FIG. 19 depicts an example of a safety work zone activity updater method 1900. In some examples, safety work zone activity updater method 1900 may be executed by work zone activity updater service 1802 and across infrastructure layer 202.

At step 1902, an equipment status update for equipment associated with an equipment owner is received. In some examples, this update may be received directly from the equipment owner's equipment or through an intervening service, such as through use of a provided authorization token from the equipment owner.

At step 1904, equipment is identified for which the equipment status update indicates a change in status.

At step 1906, applicable activity rules are determined based on equipment type. In some examples, additional contextual data, like time, material deliveries within a certain time and/or geographic window, and more may be used to determine activity rules.

At step 1908, a corresponding work zone is determined based on the equipment owner identification, project specification data in a project database, and/or equipment geolocation data.

At step 1910, the corresponding work zone is flagged by applying the applicable activity rules to the equipment status update.

At step 1912, the project database is updated to reflect the activity alert and work zone change.

At step 1914, an indicator is transmitted to receiving navigation services that the work zone is active. As a result, drivers may be automatically alerted as they approach a flagged safety work zone.

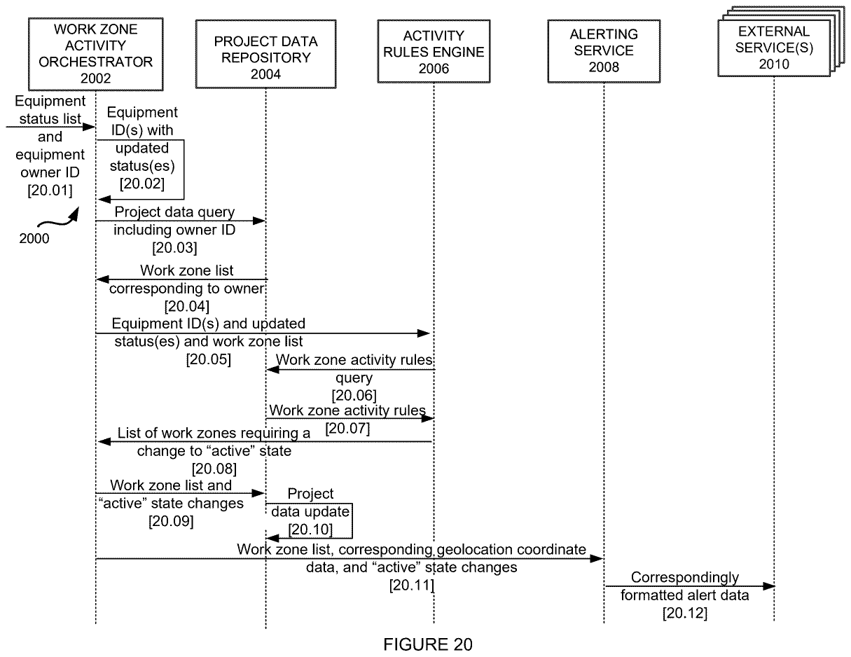

FIG. 20 is a sequence diagram depicting a process sequence 2000 for activating safety work zones. A work zone activity orchestrator 2002 receives an equipment status list an equipment owner identification 20.01. Work zone activity orchestrator 2002 then extracts equipment identifiers with an updated status 20.02. In some examples, the received equipment status list provides naïve status information and does not innately identify equipment with updated statuses.

Work zone activity orchestrator 2002 sends a project data query including the owner identification 20.03 to a project data repository 2004. Project data repository 2004 responds to work zone activity orchestrator 2002 with a work zone list corresponding to the owner identification 20.04.

Work zone activity orchestrator 2002 sends a list of equipment identifications, corresponding updated statuses, and work zones list 20.05 to an activity rules engine 2006. Activity rules engine 2006 sends a work zone activity rules query 20.06 to project data repository 2004. In some examples, the work zone activity rules query includes contextual information like equipment owner identification, activity status, and more. Project data repository 2004 responds to activity rules engine 2006 with a reference to or executable work zone activity rules 20.07.

Activity rules engine 2006 then sends a list of work zones requiring a change to active status 20.09 to work zone activity orchestrator 2002. Work zone activity orchestrator 2002 sends a work zone list and active status changes 20.09 to project data repository 2004. Project data repository 2004 then updates project data 20.10 accordingly.

Work zone activity orchestrator 2002 also sends a work zone list, corresponding geolocation coordinate data, and active status changes 20.11 to an alerting service 2008. Alerting service 2008 is configured to format work zone active status changes as necessary for various external service(s) 2010. Accordingly, alerting service 2008 sends correspondingly formatted alert data 20.12 to external service(s) 2010.

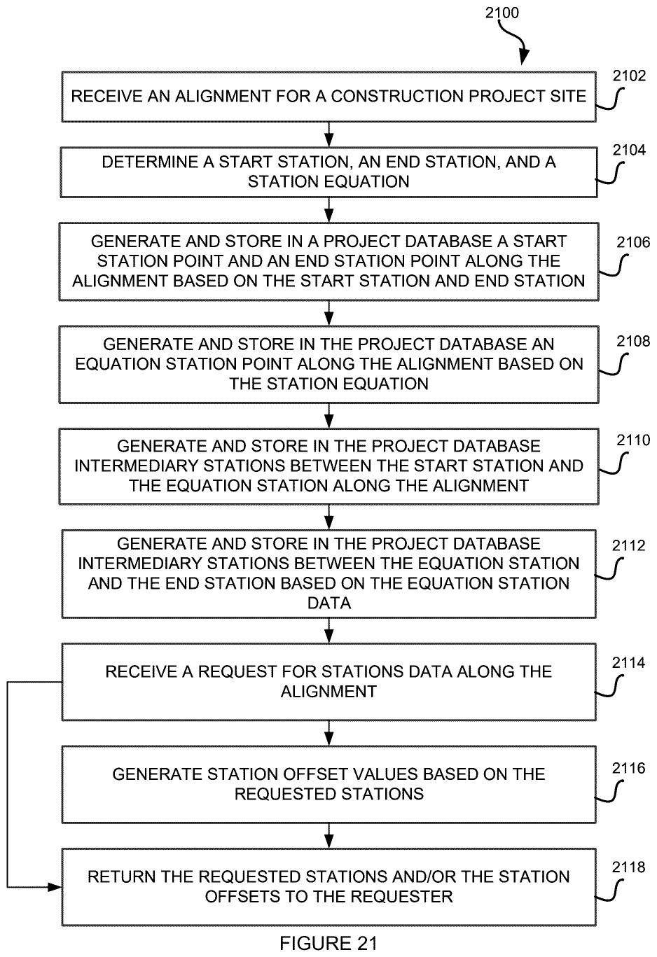

FIG. 21 depicts an example of a station equation handler method 2100. In some examples, station equation handler method 2100 may be executed by station equation service 1114 and/or stationing manager 1110, and/or across infrastructure layer 202.

At step 2102, an alignment is received for a construction project site. The alignment may include data identifying the geographic position of the start point, end point, and geometry data linking the two points, according to a projection associated with the construction project.

At step 2104, the start station, end station, and station equation are determined from the received alignment. The start station and end station may be located at the start point and end point of the alignment. The station equation may be extracted from the alignment data or may be calculated based on additional station data in the received alignment file or other contextual data.

At step 2106, the start station and end station records are generated and saved in a project database for later retrieval and/or processing.

At step 2108, an equation station is generated based on the station equation. The equation station is a virtual station located along the alignment in accordance with the station equation and may be stored in the project database as a station record.

At step 2110, intermediary stations are distributed along the alignment according to a predetermined sequence (e.g., every 100 feet as measured along the alignment) from the start station and up to the equation station. Each of these intermediary stations are stored as station records in the project database.

At step 2112, intermediary stations are then distributed along the alignment according to the predetermined sequence from the equation station and up to the end station. Each of these intermediary stations are likewise stored as station records in the project database. In generating intermediary stations of steps 2110 and/or 2112, the determined offset components of the station equation may be used to modify the placement of the intermediary station immediately before and/or after the equation station.

At step 2114, a request is received for stations data along the alignment. The request may originate from a service within infrastructure layer 202 or from an external requestor, such as a user mobile device or laptop. The request may include a project identifier and/or an alignment identifier by which to look up the appropriate station records.

In some examples, step 2116 may be performed, and station offsets may be generated (e.g., for displaying intermediary tick marks interleaving the stations, etc.) by the stationing manager service.

At step 2118, if step 2116 was performed, the station data and offsets are returned to the requesting service. In some examples, only the stations data may be returned to the requesting service, and offset data may be generated by the requester or through an external process.

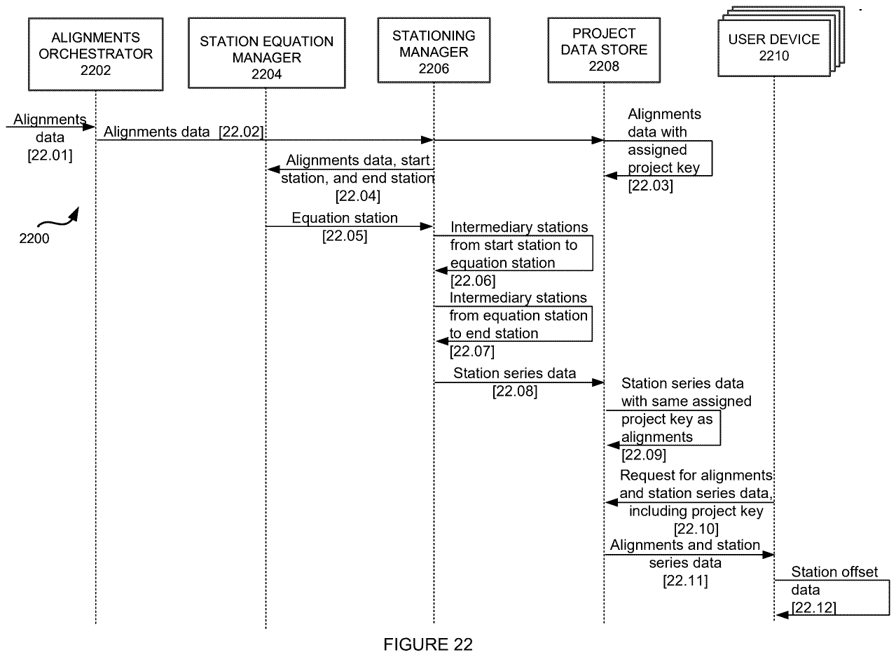

FIG. 22 is a sequence diagram depicting a process sequence 2200 for generating stations data while handling a station equation. An alignments orchestrator 2202 receives alignments data 22.01 for generating stations data. In some examples, alignments orchestrator 2202 may generate alignments data 22.01 itself. Alignments orchestrator 2202 then sends alignments data 22.02 to stationing manager 2206 for stationing and to project data store 2208 for storage.

Project data store 2208 then assigns a project key to the alignments data and stores them as a record 22.03. Stationing manager 2206 determines alignments data, start station data, and end station data 22.04 and provides it to station equation manager 2204.

Station equation manager 2204 uses the received data 22.04 to generate equation station data 22.05 which is then returned to stationing manager 2206. Stationing manager 2206 generates intermediary stations between the start station and the equation station 22.06 by applying a stationing algorithm to the alignment, start station, and equation station. Stationing manager 2206 then generates intermediary stations between the equation station and the end station 22.07 by applying a stationing algorithm to the alignment, equation station, and end station. Stationing manager 2206 then sends the start station, station equation, end station, and intermediary stations as station series data 22.08 to project data store 2208.

Project data store 2208 stores the received station series data with the same project key as the stored alignments data 22.09. At some point, a user device 2210 transmits a requests for alignments and station series data with the project key 22.10 to project data store 2208. Project data store 2208 retrieves the requested data using the project key and returns alignments and station series data 22.11 to user device 2210. User device 2210 then generates individual station offset data 22.12 according to stored preferences.

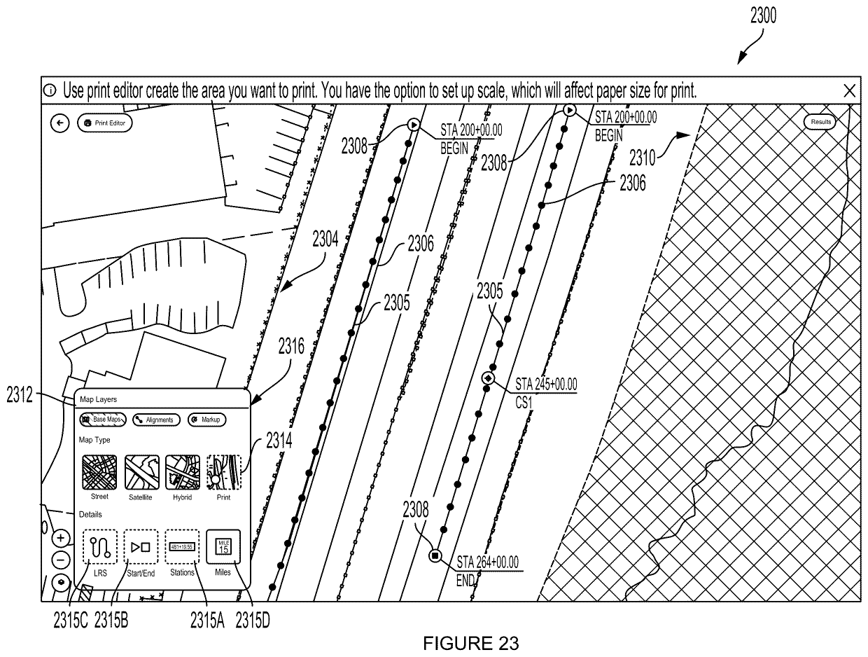

FIGS. 23-25 depict an example of a UX flow for exporting stations and alignments to a ledger styled printout. FIG. 23 depicts view 2300 which includes a simplified line render of a project site with alignment and station information overlaid.

Users switch to view 2300 by selecting a “Print” map type selection 2314 in a map layers modal 2312. Additional details can be optionally toggled on and off in map layers modal 2312 by interacting with a stations toggle 2315A, a start/end toggle 2315B, a LRS toggle 2314C, which are all toggled on as depicted in FIG. 23, and a mile marker toggle 2315D. Area terrain features and topographies 2304 are rendered in a simplified line drawing style.

Here, because stations toggle 2315A, start/end toggle 2315B, and LRS toggle 2314C are selected, alignments 2305, LRS markers 2306, and stations 2308 each are displayed on a map 2310.

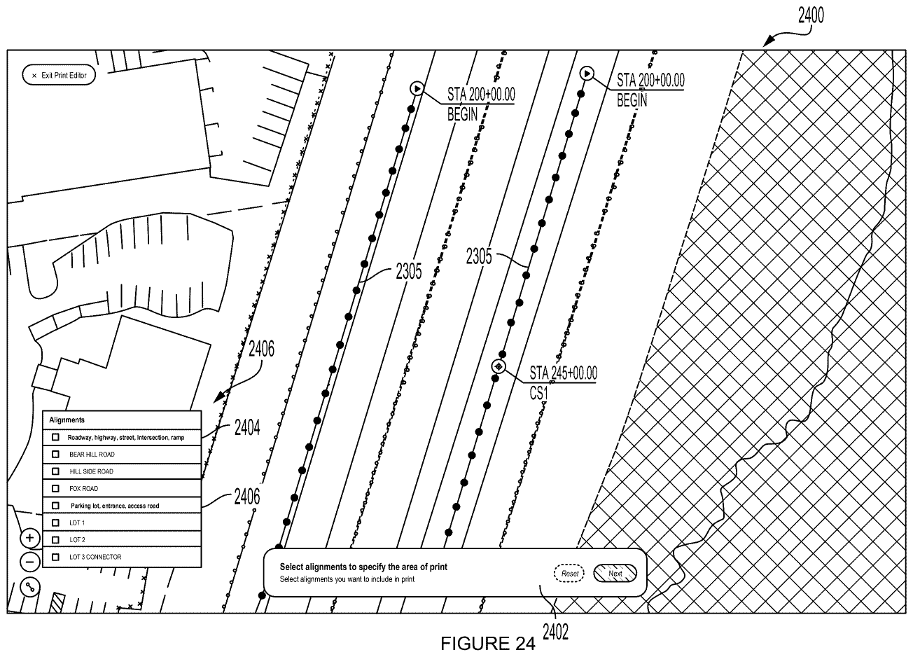

FIG. 24 depicts view 2400, which users enter from view 2300 when they begin the export to print process. Alignments 2305 and other toggled on items persist into view 2400 as users are prompted by a modal 2402 to specify alignments intended for print export. Users may do this by selecting any alignments from an alignments modal 2406, which displays alignment options by type. Here, roadway, highway, street, intersection, and ramp type 2404 alignments are available, as well as parking lot, entrance, and access road type 2406 alignments.

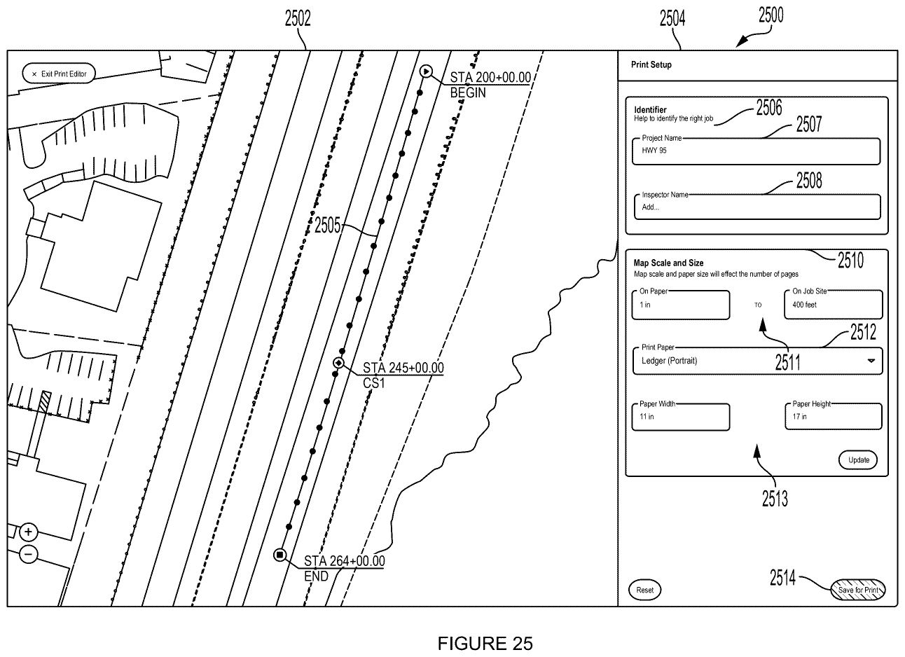

FIG. 25 depicts a view 2500 of the export to print process following selection of alignment 2505. Once selected alignments have been confirmed, other alignments are hidden from export preview 2502. A menu sidebar 2504 includes an identifier section 2506 and a scale and size section 2510. Users may input a project name and inspector name via a project name field 2507 and an inspector name field 2508 of identifier section 2506. In some examples, the project name and/or inspector name may be embedded into the export image in a format optimized for importing a marked up version of the exported document back into the system (e.g., bar code, QR code, etc.). Scale and size section 2510 includes a scale ratio field 2511, print orientation and paper type field 2512, and print size fields 2513. Scale ratio field 2511 enables users to define a ratio of depicted feet on the worksite to inches on the print export. Print orientation and paper type field 2512 is a drop down tab by which users may select from a list of paper types (e.g., ledger, letter, legal, A1, A2, etc.) and orientations, such as portrait or landscape. Print size field fields 2513 enable a user to further refine the size of the export image to be printed.

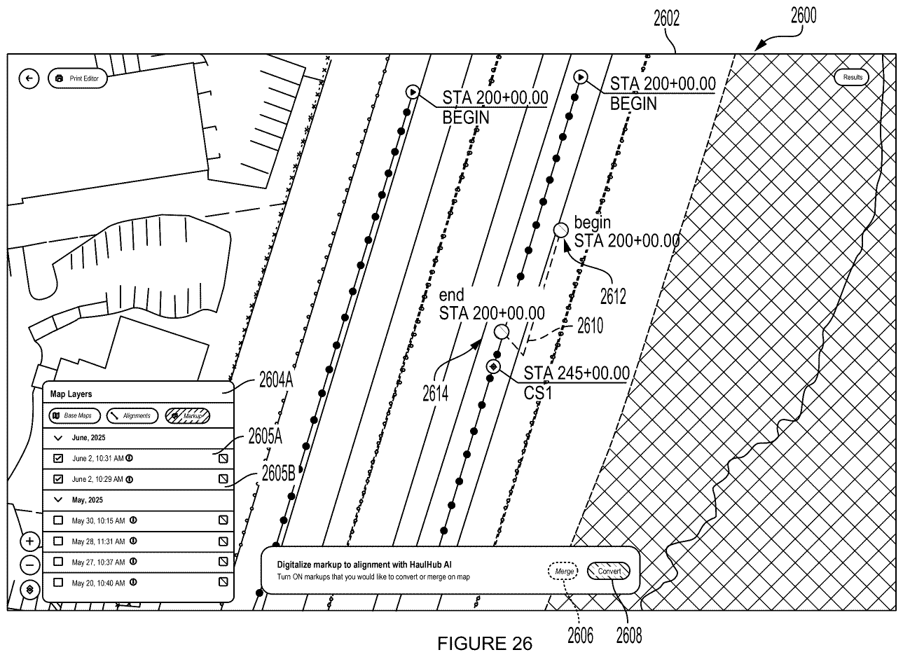

FIGS. 26-31 depict an example UX flow for importing handwritten notes on a physical plan sheet into the system. As depicted here, alignments and stations are imported, but it is understood that other kinds of markup may be imported in a similar manner as depicted.

FIG. 26 depicts view 2600 in which uploaded markups 2605A and 2605B have been selected from a map layers modal 2604A for display in map viewer 2602. Uploaded markups 2605A and 2605B may be scanned annotated plan sheets or cropped digital photos of annotated plan sheets.

Here, handwritten markup can be seen depicting an alignment 2610, start station 2612, and end station 2614. From view 2600 users may select to convert markup to digital format via a convert button 2608 or merge multiple markups, such as markups 2605A and 2605B, into a single markup layer via a merge button 2606. In some examples, if multiple markups are converted simultaneously, they will automatically be merged into a single layer before conversion.

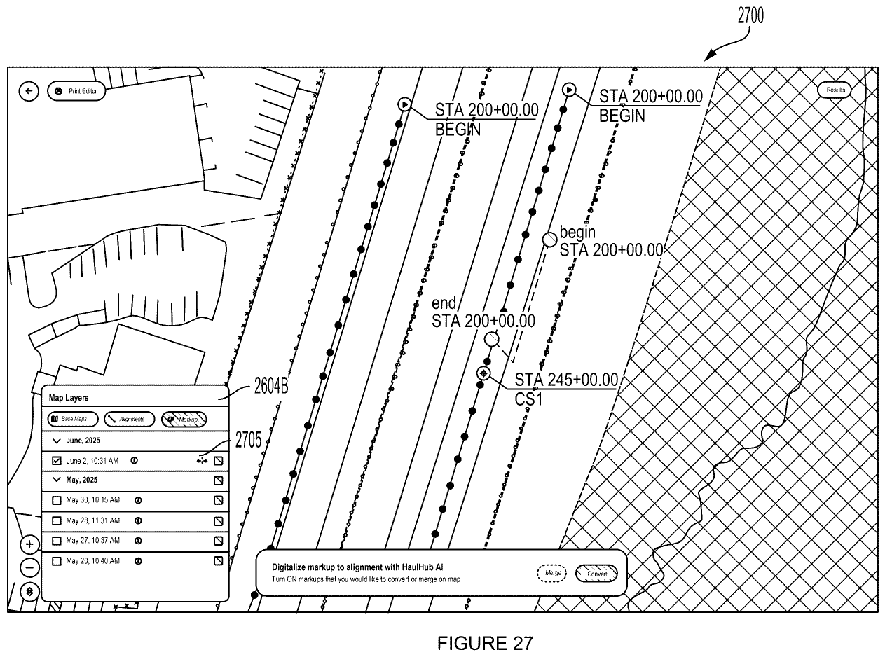

FIG. 27 depicts a view 2700 where only a single markup 2705 has been selected from a map layers modal 2604B. In contrast to view 2600, the merge function is made unavailable for users to interact with in view 2700 because there are not enough selected markup layers to perform a merge.

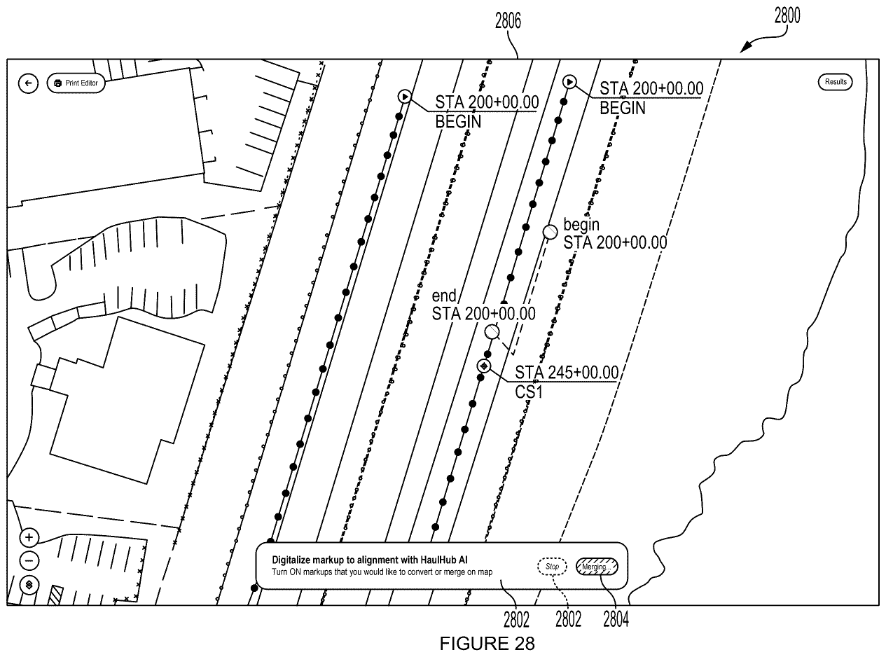

FIG. 28 depicts a view 2800 which includes a notification modal 2802 to users that markups are currently being merged. Notification modal 2802 includes a merge button 2804 which ceases to be interactable while multiple markup layers are being merged into a single markup layer. Meanwhile, a map viewer 2806 also ceases to be interactable and fades out until the merge is completed or stopped in response to user interaction with a stop button 2808 in notification modal 2802. In some examples, merging layers may take a significant amount of time as the distinct markings in each layer are isolated from the shared features and each placed onto a common layer copy of the shared features.

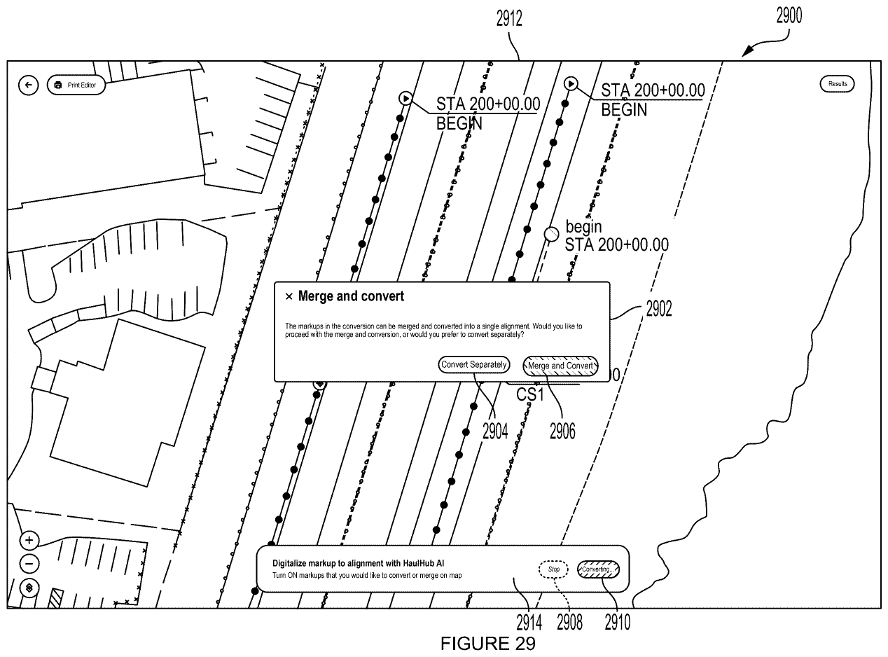

FIG. 29 depicts a view 2900 which includes similar elements to view 2800 described above. However, view 2900 is displayed when a user has elected to convert multiple markup layers to digital format. A notification modal 2914, hovered over a map display 2912, includes a stop button 2908 and a convert button 2910, which cannot be interacted with while the conversion process is underway. A notification modal 2902 is displayed centrally to catch the user's attention and prompts the user to select one of two modes of carrying out the conversion operation by interacting with a convert separately button 2904 or a merge and convert button 2906. Convert separately button 2904 will convert each individual markup layer into distinct digital components (e.g., alignments, stations, etc.), while merge and convert button 2906 will first merge the markup layers as described above and then convert the combined markup layer into digital components.

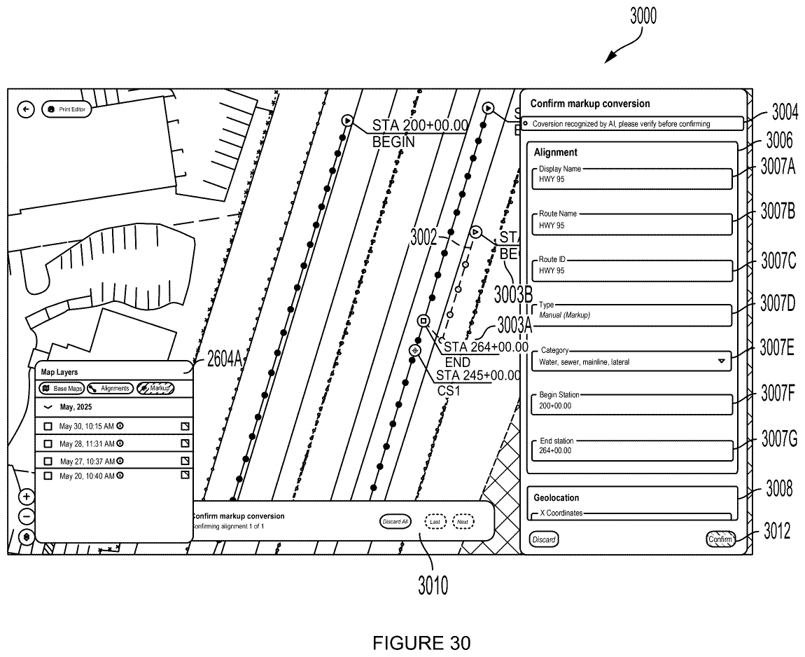

FIG. 30 depicts a view 3000 resulting from a successful markup conversion, as indicated by a markup conversion confirmation modal 3010. Here, alignment 2610 as well as start station 2612 and end station 1614 have been successfully converted into a digital alignment 3002 and digital start station 3003B and digital end station 3003A. Markup conversion confirmation modal 3010 cannot be interacted with until missing or incorrect details in a markup conversion pane 3004 have been filled in. Markup conversion pane 3004 includes an alignment section 3006 and a geolocation section 3008. Alignment section 3006 includes a display name field 3007A, a route name field 3007B, a route ID field 3007C, an alignment type field 3007D, an alignment category dropdown selection 3007E, a start station field 3007F, and an end station field 3007G. Geolocation section 3008 may include, but is not depicted here, fields for geographic coordinates and projections. Users may interact with a confirm button 3012 in markup conversion pane 3004 to finalize the details of new digital alignments and/or stations.

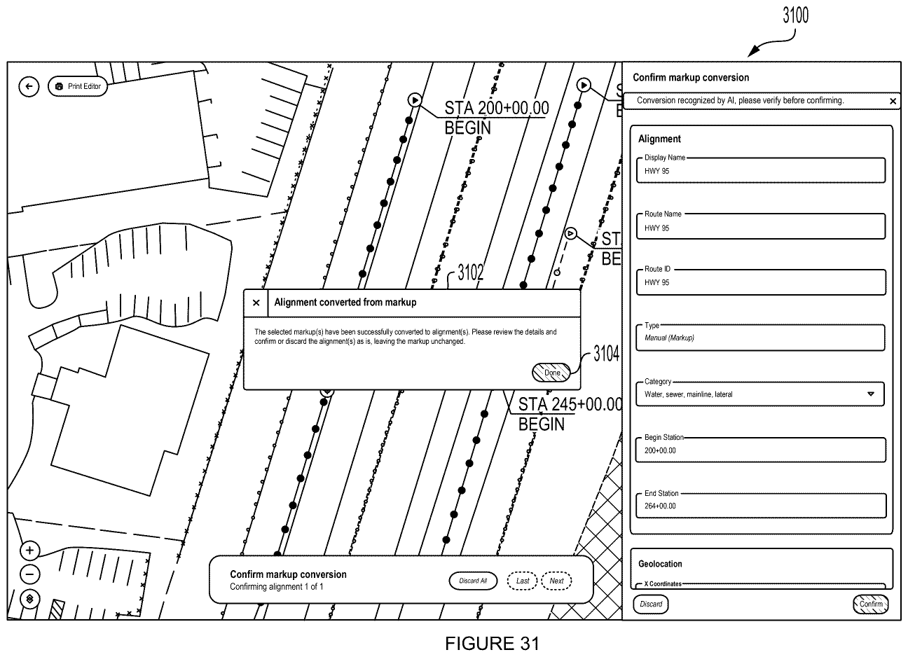

FIG. 31 depicts a view 3100 that, in some examples, may precede view 3000. View 3100 includes a notification modal 3102 that informs users that the markup has been successfully converted into digital formats and stored in a corresponding project database. Users may proceed to view 3000 by interacting with a done button 3104 in notification modal 3102.

The illustrations of the examples described herein are intended to provide a general understanding of the structure of the various embodiments. The illustrations are not intended to fully describe all the elements and features of the disclosure described herein. Many other examples may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive. Any subsequent arrangement designed to achieve the same or similar purpose may be substituted for the specific examples shown. This disclosure is intended to cover all subsequent adaptations or variations of various embodiments. The appended claims are intended to cover all such modifications, enhancements, and other embodiments which fall within the scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A computer-implemented method for generating construction project station data, the method comprising:
accessing, by a server, construction project data comprising alignments of a construction project;
automatically extracting, by the server, one or more of the alignments from the construction project data;
determining, by the server, respective station values along each of the extracted alignments;
generating, by the server, a station equation for one or more of the extracted alignments and the corresponding respective station values, wherein the station equation comprises a back-station value and a back offset and a forward-station value and a forward offset, the back offset and the forward offset comprising respective values defining positional adjustments relative to the corresponding respective station values;
geolocationally associating, by the server, one or more of the one or more extracted alignments, the corresponding respective station values, or the station equation to a mapping data standard;
storing, by the server and in a database associated with the construction project, project station data comprising the extracted alignments, the respective station values, the station equation, and the geolocational association;
retrieving, by the server, the generated station equation from the database based on the construction project; and
applying, by the server, the generated station equation responsive to the station values along one or more of the geolocationally associated alignments to provide consistent and accurate geographic positioning along the one or more of the geolocationally associated alignments, the one or more of the geolocationally associated alignments comprising one or more of a plurality of linearly adjacent alignments or a discontinuity, the discontinuity comprising one or more of an interruption or inconsistency in corresponding station values of one of the geolocationally associated alignments.

2. The computer-implemented method of claim 1, wherein applying the station equation comprises calculating an offset between the back-station value and the forward-station value that corresponds to a single geographic location, and using the offset to reconcile downstream station values for continuity of numeric stationing across the one or more of the geolocationally associated alignments.

3. The computer-implemented method of claim 1, further comprising generating a set of station offsets, based on the station equation, for one or more of the extracted alignments, the station offsets respectively coupled to the corresponding respective station values.

4. The computer-implemented method of claim 1, further comprising rendering on an interactable display of a receiving device one or more of the extracted alignments and stationing information, based on the geolocational association and the station equation.

5. The computer-implemented method of claim 4, wherein the rendered alignments and stationing information are toggleable between visibility states and the interactable display comprises a map based on the mapping data standard, the map comprising a location indicator that is reactive to a geographic location of the receiving device.

6. The computer-implemented method of claim 1, wherein geolocationally associating the extracted alignments, the corresponding respective station values, or the station equation to the mapping data standard further comprises applying a projection accounting for curvature of the Earth.

7. The computer-implemented method of claim 6, wherein the applied projection is selected by a user.

8. The computer-implemented method of claim 1, wherein the construction project data is generated by a user interacting with an interactable map based on the mapping data standard.

9. The computer-implemented method of claim 1, further comprising:
receiving, by the server and from a user, a new alignment; and
updating, by the server, the construction project data to include the new alignment.

10. The computer-implemented method of claim 9, further comprising providing the user a render of a government provided reference system as a guide for drawing the new alignment.

11. The computer-implemented method of claim 5, wherein the toggleable visibility states comprise (a) all alignments visible, (b) no alignments visible, (b) only automatically extracted alignments visible, and (c) only new alignments received from a user visible.

12. The computer-implemented method of claim 4, wherein the receiving device comprises a mobile device.

13. The computer-implemented method of claim 4, further comprising associating, by the server, a physical location value of the receiving device with one or more of the station values based on one or more of a received selection interactable display or contextual factors comprising one or more of a proximity value of the geolocationally associated extracted alignments or the corresponding respective station values to the receiving device, a priority value, a task directly or indirectly associated with the receiving device, environmental data, time data, historical data, or financial data.

14. The computer-implemented method of claim 1, wherein the linearly adjacent alignments comprise one or more of merge or tie-in reoperations.

15. The computer-implemented method of claim 1, wherein the discontinuity comprises one or more of reset or re-baselining operations.

16. A system for generating construction project station data, the system comprising:
a server comprising one or more computer processors; and
a memory comprising instructions to:
access, by a server, construction project data comprising alignments of a construction project;
automatically extract, by the server, one or more of the alignments from the construction project data;
determine, by the server, respective station values along each of the extracted alignments;
generate, by the server, a station equation for one or more of the extracted alignments and the corresponding respective station values, wherein the station equation comprises a back-station value and a back offset and a forward-station value and a forward offset, the back offset and the forward offset comprising respective values defining positional adjustments relative to the corresponding respective station values;
geolocationally associate, by the server, one or more of the one or more extracted alignments, the corresponding respective station values, or the station equation to a mapping data standard;
store, by the server and in a database associated with the construction project, project station data comprising the extracted alignments, the respective station values, the station equation, and the geolocational association;
retrieve, by the server, the generated station equation from the database based on the construction project; and
apply, by the server, the generated station equation responsive to the station values along one or more of the geolocationally associated alignments to provide consistent and accurate geographic positioning along the one or more of the geolocationally associated alignments, the one or more of the geolocationally associated alignments comprising one or more of a plurality of linearly adjacent alignments or a discontinuity, the discontinuity comprising one or more of an interruption or inconsistency in corresponding station values of one of the geolocationally associated alignments.

17. The system of claim 16, wherein the memory further comprises instructions to render on an interactable display of a receiving device one or more of the extracted alignments and stationing information, based on the geolocational association and the station equation.

18. The system of claim 17, wherein the rendered alignments and stationing information are toggleable between visibility states and the interactable display comprises a map based on the mapping data standard, the map comprising a location indicator that is reactive to a geographic location of the receiving device.

19. The system of claim 16, wherein geolocationally associating the extracted alignments, the corresponding respective station values, or the station equation to the mapping data standard further comprises applying a projection accounting for curvature of the Earth.

20. The system of claim 17, wherein the applied projection is selected by a user.

21. The system of claim 16, wherein the construction project data is generated by a user interacting with an interactable map based on the mapping data standard.

22. The system of claim 16, wherein the memory further comprises instructions to:
receive from a user a new alignment; and
update the construction project data to include the new alignment.

23. The system of claim 22, wherein the memory further comprises instructions to provide the user a render of a government provided reference system as a guide for drawing the new alignment.

24. The system of claim 18, wherein the toggleable visibility states comprise (a) all alignments visible, (b) no alignments visible, (b) only automatically extracted alignments visible, and (c) only new alignments received from a user visible.

25. The system of claim 18, wherein the receiving device comprises a mobile device.

26. The system of claim 18, wherein the memory further comprises instructions to associate a physical location value of the receiving device with one or more of the station values based on one or more of a received selection interactable display or contextual factors comprising one or more of a proximity value of the geolocationally associated extracted alignments or the corresponding respective station values to the receiving device, a priority value, a task directly or indirectly associated with the receiving device, environmental data, time data, historical data, or financial data.

27. The system of claim 16, wherein the memory further comprises instructions to associate, by the server, the physical location of the receiving device with one or more of the geographically associated alignments.

28. The system of claim 24, wherein the physical location is associated with the one or more of the geographically associated alignments based on whether the respective geographically associated alignment is in one of the toggleable visibility states.

29. The system of claim 24, wherein the physical location is associated with the one or more of the geographically associated alignments based on one or more of a plurality of contextual factors associated with the respective geographically associated alignment, the contextual factors comprising a proximity value of the respective geographically associated alignment to the receiving device, a priority value, a task directly or indirectly associated with receiving device, environmental data, time data, historical data, or financial data.

30. The system of claim 16, wherein the linearly adjacent alignments comprise one or more of merge or tie-in reoperations.

31. The system of claim 16, wherein the discontinuity comprises one or more of reset or re-baselining operations.

32. A non-transitory computer readable medium storing instructions that, when executed by one or more processors, cause the one or more processors to:
access construction project data comprising alignments of a construction project;
automatically extract one or more of the alignments from the construction project data;
determine respective station values along each of the extracted alignments;
generate a station equation for one or more of the extracted alignments and the corresponding respective station values, wherein the station equation comprises a back-station value and a back offset and a forward-station value and a forward offset, the back offset and the forward offset comprising respective values defining positional adjustments relative to the corresponding respective station values;
geolocationally associate one or more of the one or more extracted alignments, the corresponding respective station values, or the station equation to a mapping data standard;
store in a database associated with the construction project, project station data comprising the extracted alignments, the respective station values, the station equation, and the geolocational association;
retrieve the generated station equation from the database based on the construction project; and
apply the generated station equation responsive to the station values along one or more of the geolocationally associated alignments to provide consistent and accurate geographic positioning along the one or more of the geolocationally associated alignments, the one or more of the geolocationally associated alignments comprising one or more of a plurality of linearly adjacent alignments or a discontinuity, the discontinuity comprising one or more of an interruption or inconsistency in corresponding station values of one of the geolocationally associated alignments.

33. The non-transitory computer readable medium of claim 32, wherein the instructions further cause the one or more processors to generate a set of station offsets, based on the station equation, for one or more of the extracted alignments, the station offsets respectively coupled to the corresponding respective station values.

34. The non-transitory computer readable medium of claim 32, wherein the instructions further cause the one or more processors to render on an interactable display of a receiving device one or more of the extracted alignments and stationing information, based on the geolocational association and the station equation.

35. The non-transitory computer readable medium of claim 34, wherein the rendered alignments and stationing information are toggleable between visibility states and the interactable display comprises a map based on the mapping data standard, the map comprising a location indicator that is reactive to a geographic location of the receiving device.

36. The non-transitory computer readable medium of claim 32, wherein geolocationally associating the extracted alignments, the corresponding respective station values, or the station equation to the mapping data standard further comprises applying a projection accounting for curvature of the Earth.

37. The non-transitory computer readable medium of claim 36, wherein the applied projection is selected by a user.

38. The non-transitory computer readable medium of claim 32, wherein the construction project data is generated by a user interacting with an interactable map based on the mapping data standard.

39. The non-transitory computer readable medium of claim 32, wherein the instructions further cause the one or more processors to:
receive, from a user, a new alignment; and
update the construction project data to include the new alignment.

40. The non-transitory computer readable medium of claim 39, wherein the instructions further cause the one or more processors to provide the user a render of a government provided reference system as a guide for drawing the new alignment.

41. The non-transitory computer readable medium of claim 35, wherein the toggleable visibility states comprise (a) all alignments visible, (b) no alignments visible, (b) only automatically extracted alignments visible, and (c) only new alignments received from a user visible.

42. The non-transitory computer readable medium of claim 34, wherein the receiving device comprises a mobile device.

43. The non-transitory computer readable medium of claim 34, wherein the instructions further cause the one or more processors to associate a physical location value of the receiving device with one or more of the station values based on one or more of a received selection interactable display or contextual factors comprising one or more of a proximity value of the geolocationally associated extracted alignments or the corresponding respective station values to the receiving device, a priority value, a task directly or indirectly associated with the receiving device, environmental data, time data, historical data, or financial data.

44. The non-transitory computer readable medium of claim 32, wherein the linearly adjacent alignments comprise one or more of merge or tie-in reoperations.

45. The non-transitory computer readable medium of claim 32, wherein the discontinuity comprises one or more of reset or re-baselining operations.

46. A computer-implemented method for alerting drivers of active work zones, the method comprising:
receiving one or more safety work zones, each safety work zone comprising a collection of digital stations and one or more digital alignments associated with one or more construction project work sites;
receiving a collection of rules for modifying an active status of each of the received one or more safety work zones based on data received from respective geographical sites corresponding to each of the received one or more safety work zones;
receiving data from one or more devices deployed to one of the respective geographical sites, the data comprising information on device state, geolocation, and identification of an owner or a user;
determining which of the received rules to apply to the received data based on one or more of the device, the geolocation, or the identification;
modifying the active status of one or more of the received safety work zones by applying the received rules to the received data, wherein the modification to the active status is logged in project data store corresponding to the one or more of the received safety work zones; and
transmitting a notification to a data consumer comprising a navigation service, wherein the notification is formatted in accordance with the data consumer.

47. The computer-implemented method of claim 46, wherein the one or more devices deployed to one of the respective geographical sites comprises one or more of a paver, a miller, a front loader, a transportation vehicle, a drone, or a mobile device.

48. The computer-implemented method of claim 46, wherein the navigation service comprises a third party application programming interface (API) endpoint accessible over the internet.

49. The computer-implemented method of claim 46, wherein receiving the data from one or more devices deployed to one of the respective geographical sites further comprises:
fetching a collection of equipment statuses from a manufacturer endpoint using an authorization token associated with a corresponding equipment owner; and
selecting equipment statuses from the collection by comparing location data of each respective equipment status with location data associated with the safety work zones;
wherein the received data is thereafter limited to data associated with the selected equipment.

50. The computer-implemented method of claim 46, wherein the rules for modifying the active status comprises one or more of a rules-based model or a trained machine learning model.

51. A computer-implemented method for generating as-built construction records, the method comprising:
receiving digital stationing data comprising one or more digital station identifiers, corresponding geolocational data, and associated alignment data;
receiving equipment data from construction equipment, the equipment data comprising an equipment identifier, geolocation data, and operating state data;
determining a relevant digital station based on the received equipment data and the received stationing data; and
updating or creating an as-built record comprising a reference to the determined relevant digital station and a construction activity based on the received equipment data.

52. The computer-implemented method of claim 51, wherein the equipment data further comprises sensor data from one or more of a GPS, LiDAR, inclinometer, or temperature.

53. The computer-implemented method of claim 51, wherein receiving the equipment data further comprises directly polling the construction equipment for the equipment data or querying a manufacturer endpoint for the equipment data.

54. The computer-implemented method of claim 51, wherein the construction activity is determined by one or more of applying a rules-based classifier to at least a portion of the received equipment data or applying a trained machine learning model to at least a portion of the received equipment data.
